(19) United States
(12) Patent Application Publication
(10) Pub. No.: US 2018/0004169 A1
(43) Pub. Date: Jan. 4, 2018

(54) WRIST APPARATUS

(71) Applicant: Seiko Epson Corporation, Tokyo (JP)

(72) Inventors: Jun MATSUZAKI, Shiojiri (JP); Kiyoto TAKEDA, Shiojiri (JP); Akira INAGAKI, Matsumoto (JP)

(21) Appl. No.: 15/615,059

(22) Filed: Jun. 6, 2017

(30) Foreign Application Priority Data
Jul. 1, 2016 (JP) 2016-131381

(51) Int. Cl. G04G 21/02; G01S 19/34; G01S 19/14; G04G 9/00; G04G 17/08; G06F 1/16; G04G 21/00

(52) U.S. Cl. CPC G04G 21/02; G04G 17/08; G01S 19/34; G06F 1/163; G01S 19/14; G04G 9/0064; G04G 21/00; H04M 2250/12

(57) ABSTRACT

A wrist apparatus (an electronic watch with sensors) includes a receiving section adapted to receive a satellite signal transmitted from a location information satellite, a plurality of sensors (an acceleration sensor, a pressure sensor, and an orientation sensor), a power supply section provided with a self-power generation function, and a display section adapted to display information using indicating hands (measurement indicating hands).

### BACKGROUND

### 1. Technical Field

The invention relates to a wrist apparatus equipped with a sensing device.

### 2. Related Art

In recent years, there has been presented a wrist apparatus equipped with a variety of types of sensing devices for detecting, for example, orientation and altitude (atmospheric pressure), and adapted to provide a user with the time and a variety of types of information obtained by the sensing devices. In, for example, JP-A-2002-40175 (Document 1), there is disclosed a portable apparatus (a wrist apparatus) provided with a pressure sensor and an electronic orientation sensor, and having a configuration in which a variety of types of information detected by the pressure sensor and the electronic orientation sensor are digitally displayed on display sections provided to a main body case and a wrist band. It should be noted that in such a portable apparatus (wrist apparatus), the digital display is considered as the mainstream since a number of display variations can be presented.

In the portable apparatus (the wrist apparatus) equipped with a variety of sensing devices as described above, the configuration in which the digital display is performed is the mainstream as described in Document 1. However, if a variety of types of information are presented by the digital display on a display section limited in size, it is hard to make out the information due to the fact that the characters become small, and the fact that a complicated image cannot sufficiently be drawn, and so on, and thus, there is a problem that the display section grows in size in order to cope with the facts, and thus the fashionability is deteriorated. Further, there is a problem that it is unable to meet the user's expectation such that in order to drive a variety of types of sensing devices, the amount of use of the battery increases, and available sensing device is limited taking the life of the battery incorporated into consideration.

### SUMMARY

An advantage of some aspects of the invention is to solve at least a part of the problems described above, and the invention can be implemented as the following forms or application examples.

### Application Example 1

A wrist apparatus according to this application example includes a receiving section adapted to receive a satellite signal transmitted from a location information satellite, a plurality of sensors, a power supply section provided with a self-power generation function, and a display section adapted to display information using an indicating hand.

According to the wrist apparatus related to this application example, since the information is displayed using the indicating hand, the visibility of the display is enhanced, and it becomes possible to display the information within the relatively small display section. Thus, even if the wrist apparatus is mounted, mounting similar to the ordinary wristwatch can be realized, and it becomes possible to improve the wearability, and at the same time improve the fashionability of the apparatus.

Further, since the self-power generation function is provided to the power supply section, it is possible to generate enough power for the power supply to the power supply section by the self-power generation, and it is possible to install the function such as the GPS relatively high in power consumption, the plurality of sensors, and so on.

According to the configurations described above, it is possible to provide the wrist apparatus capable of obtaining the information including the information the user wants in everyday life such as the location information due to, for example, the GPS (global positioning system).

### Application Example 2

In the wrist apparatus according to the application example described above, it is preferable that the sensor includes either of an acceleration sensor, a pressure sensor, and an orientation sensor each adapted to detect a physical quantity.

According to this application example, in addition to, for example, the location information due to the GPS (global positioning system), the information such as the moving amount (the exercise amount) including the moving direction and the difference in altitude of the user (the wearer) based on the detection result by, for example, the acceleration sensor, the pressure sensor, and the orientation sensor can easily be obtained as the information the user wants.

### Application Example 3

In the wrist apparatus according to the application example described above, it is preferable that the sensor includes either of an illuminance sensor, a temperature sensor, and a humidity sensor each adapted to detect a physical quantity.

According to this application example, it is possible to easily obtain the information related to the prediction of the weather such as how the weather is going to change from now.

### Application Example 4

In the wrist apparatus according to the application example described above, it is preferable that the sensor is a biological information detection sensor including either of a pulse wave measurement sensor, a pulse rate measurement sensor, a blood pressure measurement sensor, a body temperature sensor, and a galvanic skin response sensor each adapted to detect biological information.

According to this application example, it is possible to easily obtain the biological information such as the pulse rate, the blood pressure value, and the blood sugar level of the user (the wearer) in addition to the location information and the information of the physical quantities. Thus, it is possible for the user to obtain the health information and the body information as a life log.

### Application Example 5

In the wrist apparatus according to the application example described above, it is preferable that there are further included a case adapted to house at least the receiving section, and a back lid part disposed on a back side of the case, and the biological information detection sensor is disposed on the back lid part.

According to this application example, since the biological information detection sensor is disposed on the back lid part, it is possible to make the biological information detection sensor adhere to the mounting part (the arm section) of the user (the wearer), and the biological information can more accurately be detected.

### Application Example 6

In the wrist apparatus according to the application example described above, it is preferable that there are further included a case adapted to house at least the receiving section, and a band part connected to the case, and the biological information detection sensor is disposed in the band part.

According to this application example, since the biological information detection sensor is disposed in the band part, the biological information detection sensor can easily be attached and detached. Thus, it is possible to easily customize the apparatus such that the type of the sensor is changed in accordance with the demand of the user.

### Application Example 7

In the wrist apparatus according to the application example described above, it is preferable that an index representing at least one of SpO₂ (percutaneous arterial blood oxygen saturation), VO₂ₘₐₓ (maximum oxygen uptake), body temperature, a lactate level, SvO₂ (oxygen saturation of hemoglobin), a sleeping condition, stress, a blood sugar level, arrhythmia, calorie consumption, metabolism, and ovulation is obtained from the biological information.

According to this application example, the body condition and the mental condition of the user (the wearer) can easily be obtained from the biological information, and it is possible for the user to easily figure out the information.

### Application Example 8

In the wrist apparatus according to the application example described above, it is preferable that the power supply section has at least either one of a power generation function of obtaining electrical energy due to a solar cell, and a power generation function of converting kinetic energy of a rotary weight to obtain electrical energy.

According to this application example, in the power supply section, the power is generated using the solar light as natural energy easy for the user to obtain, or using the motion of the arm of the user (the wearer), and therefore, it is possible to use so-called clean energy having no influence on the environment as the power source (power supply).

### Application Example 9

In the wrist apparatus according to the application example described above, it is preferable that there is further included a communication section adapted to transmit and receive a signal between the wrist apparatus and another electronic apparatus, and the communication section performs transmission and reception of the signal with one of wireless communication and wired communication.

According to this application example, it is possible to transmit the location information and the information detected by the plurality of sensors to the electronic apparatus such as a personal computer (PC) or a mobile apparatus to check the information. Although the wrist apparatus has a relatively small display section due to the portability, in comparison with such a wrist apparatus, these electronic apparatuses use a large display section, and therefore, it is possible to display the necessary information in an eye-friendly manner. Further, it is possible to perform the exchange of the information between the user and other users.

### Application Example 10

In the wrist apparatus according to the application example described above, it is preferable that the indicating hand is rotated by a rotary shaft connected to the indicating hand, and a drive section adapted to rotate the rotary shaft.

According to this application example, since the rotatable indicating hand performs the analog display of the information, it becomes possible to configure a small-sized display section, the whole of the apparatus can be miniaturized to enhance the fashionability, and at the same time, improve the wearing feeling.

### Application Example 11

In the wrist apparatus according to the application example described above, it is preferable that the display section is provided with a digital display section displayed using digital display.

According to this application example, by digitally displaying the indicating hand in the digital display section provided to the display section, it becomes possible to easily change the design and the display information.

### Application Example 12

In the wrist apparatus according to the application example described above, it is preferable that the digital display section uses at least one of an electrophoretic display module, an organic electro-luminescence display and a liquid crystal display.

According to this application example, it is possible to easily perform the digital display. It should be noted that if the electrophoretic display module (EPD) is used, the power consumption is suppressed, and at the same time, good visibility can be obtained in a bright place. Further, according to the display using the organic electro-luminescence (OLED), an excellent color developing property can be obtained, and the luminance can be improved. Further, according to the display using the liquid crystal (LCD), the price is moderate, and the influence on the temperature variation can be reduced.

### Application Example 13

In the wrist apparatus according to the application example described above, it is preferable that the display section is provided with a small window section.

According to this application example, the pieces of information detected by the plurality of sensors can be displayed in the small window sections different from each other. Thus, it is possible to display the pieces of information thus detected in an easy-to-understand manner.

### Application Example 14

In the wrist apparatus according to the application example described above, it is preferable that the number of the small window sections to be disposed is preferably in a range of not smaller than 1 and not larger than 4.

According to this application example, by setting the number of the small window sections in the range of not smaller than 1 and not larger than 4, it is possible to set the size of the small window sections to an appropriate size superior in visibility. In other words, if the number of the small window sections is 5 or more, each of the small window sections becomes small in size in the limited space of the display section, the visibility of the information displayed thereon degrades, and it becomes difficult to visually recognize the information at a glance.

### Application Example 15

In the wrist apparatus according to the application example described above, it is preferable that there is further included a plurality of operation modes in which operations corresponding respectively to the sensors are performed, and at least one of the small window sections is provided with mode display sections corresponding respectively to the operation modes.

According to this application example, it is possible to easily identify in which operation mode the information is displayed among the plurality of pieces of information detected by the plurality of sensors.

### Application Example 16

In the wrist apparatus according to the application example described above, it is preferable that the case is formed of metal.

According to this application example, the disturbance noise from the outside of the case having an influence on the detection result of the sensors housed in the case can be shielded. Further, it is possible to evoke a high-class taste and improve fashionability.

### Application Example 17

In the wrist apparatus according to the application example described above, it is preferable that an antenna provided to the receiving section is at least one of a ring antenna and a patch antenna.

According to this application example, it is possible to easily fit (house) the wrist apparatus into a small-sized apparatus. For example, if the ring antenna is used, the reception sensitivity can be enhanced, and if the patch antenna is used, it is possible to increase the degree of design freedom of the apparatus such as the arrangement layout of the sensors.

### Application Example 18

In the wrist apparatus according to the application example described above, it is preferable that there is further included at least one of a chronograph function and a dual time function.

According to this application example, it becomes possible to further provide a variety of types of timepiece (time measurement) information the user desires.

### Application Example 19

In the wrist apparatus according to the application example described above, it is preferable that the information is displayed using both of analog display and digital display.

According to this application example, by using both of the analog display and the digital display at the same time, it is possible to increase the types of the information and the amount of the information to be provided.

### Application Example 20

In the wrist apparatus according to the application example described above, it is preferable that it is further included a time correction section adapted to obtain time information included in the satellite signal to correct current time.

According to this application example, it is possible to obtain the time information corrected by the time correction section adapted to obtain the time information included in the satellite signal to correct the current time.

### Application Example 21

In the wrist apparatus according to the application example described above, it is preferable that it is further included a second receiving section adapted to receive a radio wave different in frequency from the satellite signal, and the time correction section performs correction of time based on a result of the reception by one of the receiving section and the second receiving section.

According to this application example, even if the either one of the radio waves cannot be received in the case in which, for example, the user is located at the place where the radio wave cannot be received, by performing the correction of the time using the other radio wave, it is possible to always continue the accurate time measurement and to display the accurate time.

### Application Example 22

In the wrist apparatus according to the application example described above, it is preferable that the wrist apparatus is connected to another sensor apparatus to display second physical information detected by the another sensor apparatus on the display section using the indicating hand.

According to this application example, it becomes possible to detect the information which cannot be detected by the wrist apparatus such as the second physical information using the other sensor apparatus to display the information on the display section of the wrist apparatus using the indicating hand, and thus, the usability can be improved.

### BRIEF DESCRIPTION OF THE DRAWINGS

The invention will be described with reference to the accompanying drawings, wherein like numbers reference like elements.

FIG. 1A is an overall view of a GPS including an electronic watch with sensors according to a first embodiment of a wrist apparatus according to the invention.

FIG. 1B is a perspective view showing a general appearance of the electronic watch with sensors according to the first embodiment.

FIG. 2 is a functional block diagram showing a configuration of the electronic watch with sensors according to the first embodiment.

FIG. 3 is a plan view showing a schematic configuration of a main body part (a display part) of the electronic watch with sensors according to the first embodiment.

FIG. 4 is a plan view showing a six-o'clock information display section, which is a small window (small window section) having a circular shape disposed on a six-o'clock side of the electronic watch with sensors shown in FIG. 3, in an enlarged manner.

FIG. 5 is a plan view showing a two-o'clock information display section in an enlarged manner.

FIG. 6 is a cross-sectional view showing a drive system of the six-o'clock information display section related to the first embodiment.

FIG. 7 is a plan view showing the drive system of the six-o'clock information display section related to the first embodiment.

FIG. 8A is a plan view showing a mechanism of the case of displaying a display mode in the six-o'clock information display section related to Modified Example 1.

FIG. 8B is a plan view showing an example of a rotary plate used for Modified Example 1.

FIG. 8C is a plan view showing another example of the rotary plate used for Modified Example 1.

FIG. 9 is a plan view showing a six-o'clock information display section related to Modified Example 2.

FIG. 10 is a functional block diagram showing a configuration of a receiving section related to Modified Example 3.

FIG. 11 is a perspective view showing a schematic configuration of the electronic watch with sensors according to a second embodiment.

FIG. 12 is a functional block diagram showing a configuration of the electronic watch with sensors according to the second embodiment.

FIG. 13 is a perspective view showing a general appearance of a modified example of the electronic watch with sensors according to the second embodiment.

FIG. 14 is a front view schematically showing a configuration example of a buckle part.

FIG. 15 is a perspective view showing a schematic configuration of an electronic watch with sensors according to a third embodiment.

FIG. 16 is a functional block diagram showing a configuration of the electronic watch with sensors according to the third embodiment.

FIG. 17 is a perspective view showing a general appearance of an electronic watch with sensors according to a modified example.

### DESCRIPTION OF EXEMPLARY EMBODIMENTS

Hereinafter, some embodiments of the invention will be described with reference to the accompanying drawings. It should be noted that in the drawings, the size and the scale of each of the sections are arbitrarily different from actual ones. Further, although the embodiments described below, which are preferable specific examples of the invention, are provided with various limitations technically preferable, the scope of the invention is not limited to these embodiments unless the description of limiting the invention thereto is particularly presented in the following descriptions.

### First Embodiment

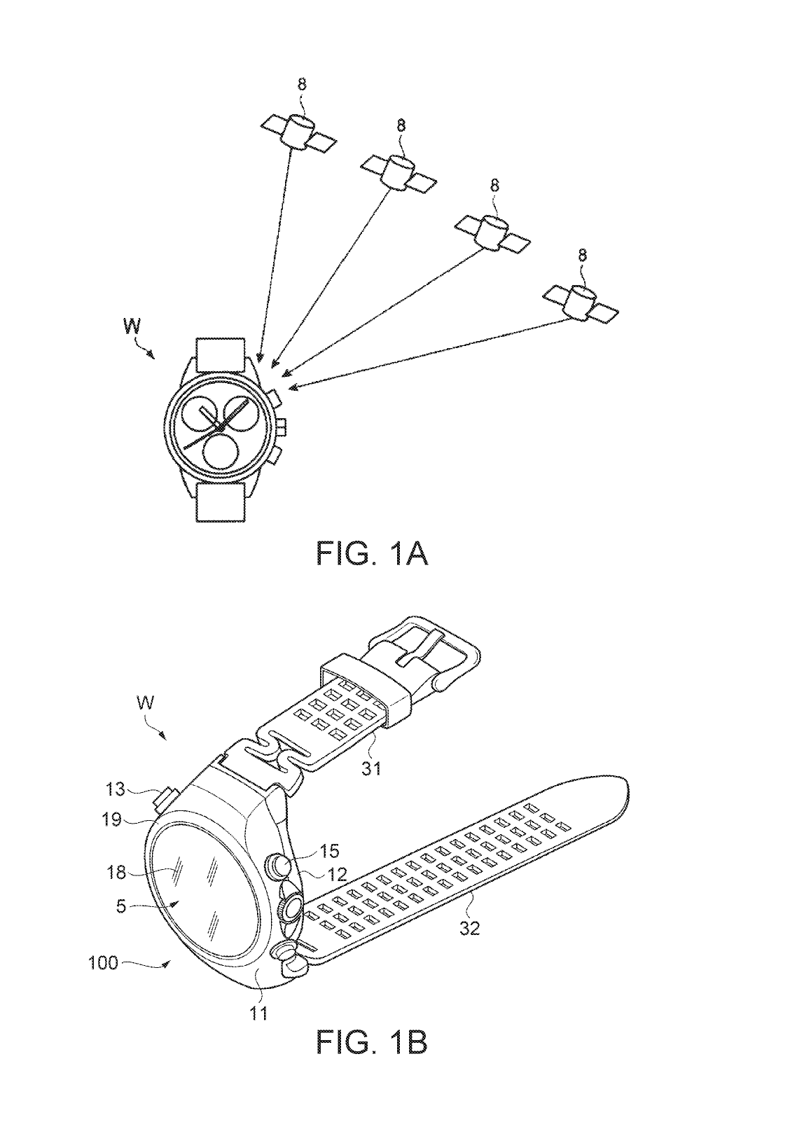

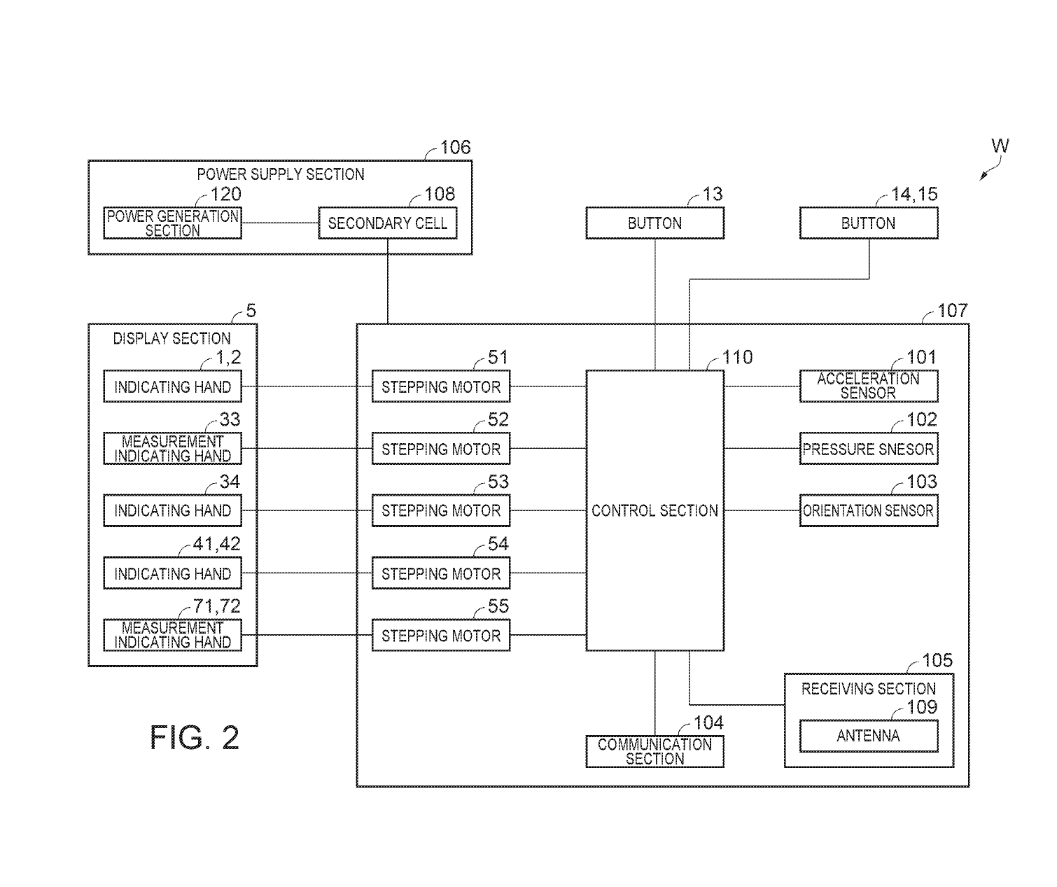

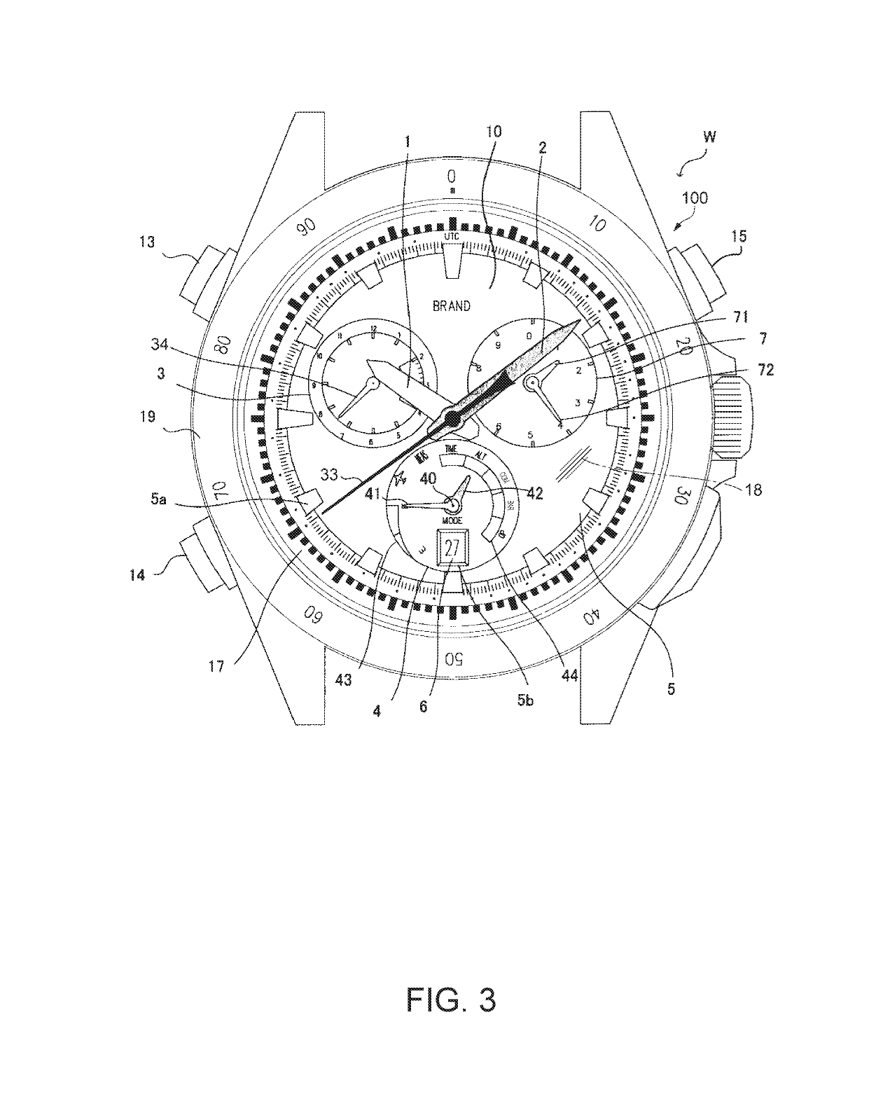

The electronic watch with sensors according to a first embodiment of the wrist apparatus according to the invention will be described with reference to FIG. 1A, FIG. 1B, FIG. 2, and FIG. 3. FIG. 1A is an overall view of a GPS (global positioning system) including the electronic watch with sensors according to the first embodiment of the wrist apparatus according to the invention. FIG. 1B is a perspective view showing a general appearance of the electronic watch with sensors according to the first embodiment. FIG. 2 is a functional block diagram showing a configuration of the electronic watch with sensors according to the first embodiment. FIG. 3 is a plan view showing a display section in an altitude measurement mode of the electronic watch with sensors according to the first embodiment.

The electronic watch W with sensors according to the first embodiment of the wrist apparatus shown in FIG. 1A, FIG. 1B, FIG. 2, and FIG. 3 is provided with a function of a wristwatch for receiving radio waves (satellite signals) from GPS satellites 8 to correct the internal time, a positioning calculation function (a function of obtaining location information) using GPS time information and orbital information, and a function of detecting information of physical quantities using a plurality of sensors. Further, the electronic watch W with sensors displays the information of the time, the location information, the information of the physical quantities, and so on with indicating hands 1, 2, 33, 34, 41, 42, 71, 72, and so on in a display section 5 (see FIG. 1B, FIG. 2) located on an opposite surface side to the surface having contact with an arm of a user (wearer).

As shown in FIG. 2, the electronic watch W with sensors according to the first embodiment is provided with a receiving section 105 for receiving a radio wave (location information) with a high frequency including the GPS time information and the orbital information from the GPS satellites 8, and a plurality of sensors such as an acceleration sensor 101, a pressure sensor 102, and an orientation sensor 103 for detecting the information of physical quantities such as acceleration, atmospheric pressure, altitude, and orientation. Further, the electronic watch W with sensors is provided with a communication section 104 for transmitting/receiving signals with other sensor apparatuses (not shown), other electronic apparatuses, and so on. Further, the electronic watch W with sensors is provided with a control section 110 for generating the location information and indication information based on the respective information detected by the plurality of sensors, and instructing display of the indication information, and a display section 5 for displaying the indication information with the indicating hands 1, 2, 33, 34, 41, 42, 71, and 72 and so on based on the instruction from the control section 110. Further, the electronic watch W with sensors is provided with a power supply section 106 provided with a self-power generation function as a power source for driving an electric circuit system 107 including the control section 110, the acceleration sensor 101, the pressure sensor 102, the orientation sensor 103, the communication section 104, the receiving section 105, and so on.

As shown in FIG. 1A, the GPS satellites 8 are an example of location information satellites each orbiting in a predetermined orbit in the midair of the earth. The GPS satellites 8 each transmit a high-frequency radio wave, on which the navigation message is superimposed, such as a radio wave (an L1 wave) at 1.57542 GHz to the ground. In the following description, the radio wave at 1.57542 GHz on which the navigation message is superimposed is referred to as a satellite signal. The satellite signal is a right-handed circularly polarized wave.

At present, a plurality of GPS satellites 8 (four satellites are shown in FIG. 1A) exists. In order to identify which GPS satellite 8 has transmitted the satellite signal, the GPS satellites 8 each superimpose a unique pattern of 1023 chips (period of 1 ms) called a coarse/acquisition code (C/A code) on the satellite signal. Each of the chips of the C/A code is either one of +1 and −1, and thus, the C/A code looks like a random pattern. Therefore, by calculating the correlation between the satellite signal and the pattern of each of the C/A codes, the C/A code superimposed on the satellite signal can be detected.

Each of the GPS satellites 8 is equipped with an atomic clock. The satellite signal includes extremely accurate GPS time information measured by the atomic clock. By a control segment located on the ground, a minute time error of the atomic clock installed in each of the GPS satellites 8 is measured. The satellite signal also includes a time correction parameter for correcting the time error. The electronic watch W with sensors receives the satellite signal (the radio wave) transmitted from one of the GPS satellites 8 to obtain the time information using the GPS time information and the time correction parameter included in the satellite signal. The operation mode in which the time information can be obtained is referred to as a “time measurement mode,” and it is possible to correct the internal time (minute and second) of the electronic watch W with sensors using the time information thus obtained.

The satellite signal also includes the orbital information representing the position on the orbit of the GPS satellite 8. The electronic watch W with sensors is capable of performing the positioning calculation using the GPS time information and the orbital information. The positioning calculation is performed on the assumption that the internal time of the electronic watch W with sensors includes a certain amount of error. In other words, the time error becomes the unknown in addition to x, y, z parameters for identifying the three-dimensional position of the electronic watch W with sensors. Therefore, the electronic watch W with sensors receives the satellite signals (the radio waves) respectively transmitted from, for example, three or more GPS satellites 8, then performs the positioning calculation using the GPS time information and the orbital information included in the satellite signals to obtain the location information at the present location. The operation mode in which the location information can be obtained is referred to as a positioning mode, and the time difference is corrected based on the location information thus obtained, and it is possible to automatically display the local time. The reception operation in the positioning mode is higher in power consumption compared to the reception operation in the time measurement mode described above, and therefore, it is preferable for the correction operation (a manual reception or an automatic reception) of the internal time in the usage environment in which the time difference correction is not required to be performed in the time measurement mode.

As shown in FIG. 1B, the electronic watch W with sensors is mounted on a given region (e.g., the wrist) of the user (the wearer), and displays the current time, and the location information, locomotion information (information of the physical quantities), and so on of the user. The electronic watch W with sensors includes an apparatus main body 100 mounted on the user to detect and display the current time, and the location information, the locomotion information (the information of the physical quantities), and so on of the user, and band parts 31, 32 attached to the apparatus main body 100 to mount the apparatus main body 100 on the user. It should be noted that it is also possible to provide a function of detecting and then displaying biological information such as pulse wave information to the electronic watch W with sensors in addition to the current time, and the location information and the locomotion information (the information of the physical quantities) of the user.

The apparatus main body 100 is provided with a bottom case 12 disposed on the side on which the apparatus is mounted on the user, and is provided with a top case 11 disposed on the opposite side to the side on which the apparatus is mounted on the user. The bottom case 12 and the top case 11 each can be formed of metal such as stainless steel, or resin, but are each preferably formed of metal. By forming the bottom case 12 and the top case 11 as the case using metal, it is possible to shield external disturbance noise, which affects the detection result of the plurality of sensors housed in the bottom case 12 and the top case 11. Further, it is possible to evoke a high-class taste and improve fashionability. Further, the configuration of being separated into the top case 11 and the bottom case 12 is not necessarily required, but it is also possible to adopt a configuration provided with a case part having an integral structure, and a back lid disposed on the side, on which the apparatus is mounted on the user, of the case part.

On the top side (in the top case 11), which is one side of the apparatus main body 100, there is disposed a bezel 19, and at the same time, there is disposed a glass plate 18 as a top plate part (an outer wall) disposed inside the bezel 19 to protect the internal structure. It is also possible for the apparatus main body 100 to have a configuration in which there is provided a display section 5 including a dial plate 10 disposed immediately below the glass plate 18 via the glass plate 18, and the user can view the display of the display section 5. In other words, in the electronic watch W with sensors according to the present embodiment, there can be adopted a configuration in which a variety of types of information such as the location information, the locomotion information (the information of the physical quantities), and the time information thus detected are displayed on the display section 5, and the display is provided to the user from the top side of the apparatus main body 100. It should be noted that the information displayed on the display section 5 is, for example, the information itself included in the satellite signal received by the receiving section, or the current time, current location, a moving distance, or the speed obtained by processing the satellite signal thus received. Alternatively, the information is physical quantities detected by the variety of sensors such as the number of steps, the atmospheric pressure, the altitude, the orientation, the temperature, and the humidity, or biological information such as the pulse wave, the pulse rate, the blood pressure, or the body temperature. Alternatively, the information can also be the information newly generated based on the information obtained by the electronic watch W with sensors. Alternatively, the information can also be a goal attainment level or a comparison value (displayed using, for example, plus or minus) to a target value (the goal) or the information (e.g., a distance, the number of steps, time, and a difference from the previous measurement value) to the target value. Further, on the side surface of the apparatus main body 100, there is a plurality of buttons 13, 15 for switching, for example, the display mode of the display on the display section 5, and switching between start and stop of hand driving of the indicating hands.

It should be noted that although the example of realizing the top plate part of the apparatus main body 100 by the glass plate 18 is described here, it is possible to form the top plate part with a material other than glass such as transparent plastic providing the member made of the material is a transparent member through which the display section 5 can be viewed, and has strength sufficient for protecting the constituents such as the display section 5 included inside the top case 11 and the bottom case 12. Further, although there is described the configuration example provided with the bezel 19, it is also possible to adopt a configuration not provided with the bezel 19. Further, a solar cell (not shown) having a power generation function due to the solar light or the like can be disposed on the surface of the bezel 19.

As shown in FIG. 2, the electronic watch W with sensors includes the control section 110, the plurality of sensors (the acceleration sensor 101, the pressure sensor 102, and the orientation sensor 103), the communication section 104, the receiving section 105, the electric circuit system 107 including stepping motors 51 through 55 as a drive section, the display section 5 for displaying the information, the power supply section 106 for driving the electric circuit system 107, and the buttons 13 through 15. It should be noted that although the three sensors, namely the acceleration sensor 101, the pressure sensor 102, and the orientation sensor 103, are illustrated as the plurality of sensors, it is sufficient to include either of the sensors.

The electronic watch W with sensors has a plurality of operation modes for performing the operations corresponding respectively to the plurality of sensors provided to the electronic watch W with sensors. For example, the acceleration sensor 101 is capable of measuring the moving direction and the moving amount of the user. The pressure sensor (the atmospheric pressure sensor) 102 is capable of obtaining the information related to the height above the sea level (the altitude) of the place (present location) where the user is located based on the atmospheric pressure value measured. The orientation sensor (a geomagnetic sensor) 103 is capable of measuring the bearing (orientation) the user faces to such as the north orientation. Further, based on the association between the direction (the moving direction) of the acceleration measured by the acceleration sensor 101 and the direction (the orientation) of the geomagnetism measured by the orientation sensor (the geomagnetic sensor) 103, it is possible to, for example, get hold of the minute actual moving performance, and obtain the information related to an amount of exercise. Here, the acceleration and the atmospheric pressure (the altitude) are each an example of the physical quantity (physical information) expressed by a numerical value.

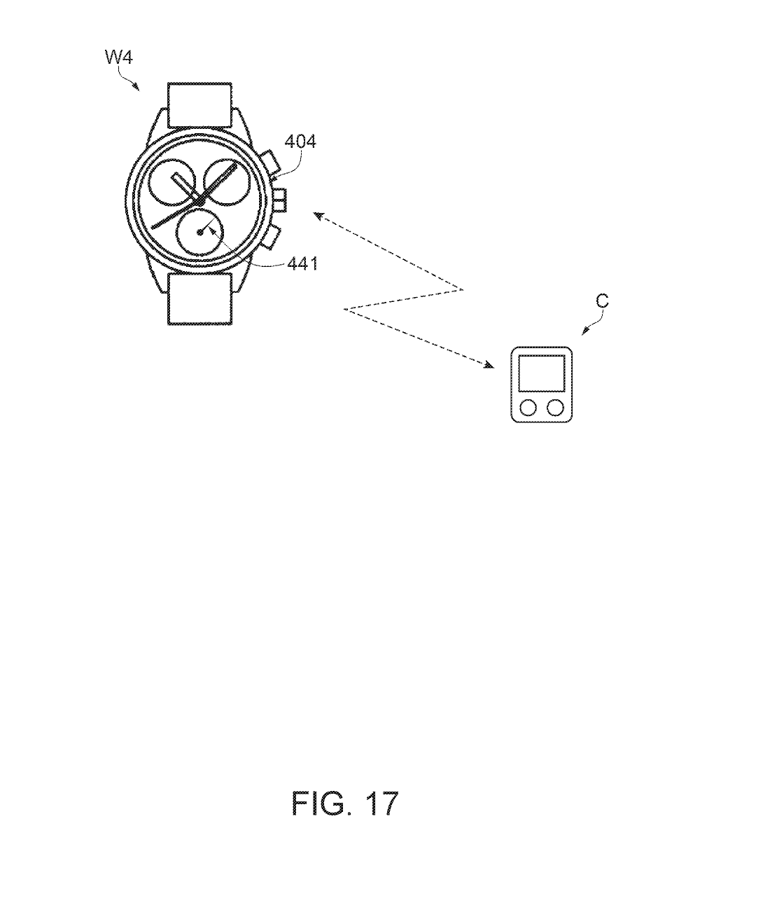

The communication section 104 is capable of communicating with another sensor apparatus C (see FIG. 17), and is capable of performing the exchange of the information measured by the other sensor apparatus C. The receiving section 105 includes an antenna 109, and has a function of receiving the satellite signals. It should be noted that it is preferable for the antenna 109 to be at least one of a ring antenna and a patch antenna. By adopting such an antenna 109, the antenna 109 can easily be fitted into the capacity of (housed by) a small apparatus. For example, if the ring antenna is used, the reception sensitivity can be enhanced, and if the patch antenna is used, it is possible to increase the degree of design freedom of the apparatus such as the arrangement layout of the sensors. Further, the buttons 13, 14, and 15 is capable of receiving the operation of the user.

Further, the electronic watch W with sensors includes the stepping motor 51 as a drive section for driving the indicating hand (an hour hand) 1 and the indicating hand (a minute hand) 2 of the display section 5, the stepping motor 52 as a drive section for driving the measurement indicating hand (the indicating hand) 33 of the display section 5, the stepping motor 53 as a drive section for driving the indicating hand (a second hand) 34 of a ten-o'clock information display section 3, the stepping motor 54 as a drive section for driving the indicating hand (a first indicating hand) 42 and the indicating hand (a second indicating hand) 41 of the six-o'clock information display section 4, and the stepping motor 55 as a drive section for driving measurement indicating hands 71, 72 of a two-o'clock information display section 7.

The control section 110 controls the electronic watch W with sensors. The control section 110 is formed of a processor such as a CPU. The control section 110 measures the time (the internal time) with, for example, an internal timepiece not shown, and then corrects the internal time using the satellite signals received by the receiving section 105.

Further, the control section 110 processes the information of the physical quantities detected by the plurality of sensors (e.g., the acceleration sensor 101, the pressure sensor 102, and the orientation sensor 103) to control the display contents of the display 5. The control section 110 operates the stepping motors 51 through 55 based on the data of the physical quantities thus processed to display the information on the display section 5.

It should be noted that it is also possible to arrange that as the display of the display section 5, the information of the physical quantities detected by the plurality of sensors (e.g., the acceleration sensor 101, the pressure sensor 102, and the orientation sensor 103) is directly displayed irrespective of the data of the physical quantities processed by the control section 110.

The button 13 receives, for example, the user operation (a holding down operation) for starting a stopwatch function in the time display mode, and the user operation (the holding down operation) for ending the stopwatch function. The button 14 receives, for example, the user operation (a holding down operation) for switching the display mode. The button 15 receives, for example, the user operation (a holding down operation) for starting the measurement of the altitude in an altitude display mode, the user operation (a holding down operation) for starting the measurement of the orientation in an orientation display mode, and the user operation (a holding down operation) for starting the measurement of the atmospheric pressure in an atmospheric pressure display mode. It should be noted that it is also possible for the button 15 to receive the user operation (the holding down operation) for starting the stopwatch function in the time display mode, and the user operation (the holding down operation) for ending the stopwatch function instead of the button 13. As described above, by providing the plurality of buttons 13 through 15, a crown, and so on, the operability for the user can be improved.

The electric circuit system 107 including the control section 110, the acceleration sensor 101, the pressure sensor 102, the orientation sensor 103, the communication section 104, the receiving section 105, and the stepping motors 51 through 55 is driven using the power supply section 106 including the power generation section 120 and a secondary cell (rechargeable battery) 108 as a power source.

The power supply section 106 has the power generation section 120 provided with a self-power generation function, and the secondary cell (the rechargeable battery) 108 which can be charged with the electrical energy generated by the power generation section 120. The power generation section 120 can be formed of a photovoltaic generation system for converting optical energy such as the solar light into electrical energy using a solar cell, or a so-called self-winding generation system for converting the kinetic energy of a rotary weight rotating due to the movement of the arm of the user into the electrical energy. It should be noted that in the present embodiment, it is sufficient to be provided with at least either one of the photovoltaic generation system and the self-winding generation system.

The solar cell (not shown) constituting the photovoltaic generation system shown as an example of the power generation section 120 can be disposed on the surface of the dial plate 10 (see FIG. 3) of the display section 5, the surface of the bezel 19, or the like. The solar cell can receive the light such as the solar light or the light of a fluorescent light to generate the power, the electrical energy thus generated is stored in the secondary cell (the rechargeable battery) 108, and is used as the energy for driving the watch and the energy for driving a variety of sensors. Further, in the self-winding generation system (not shown) described as an example of the power generation section 120, a permanent magnet is rotated in the vicinity of a coil using the movement of a rotary weight having a semicircular shape and rotating due to the motion of the arm of the user, the current (the electrical energy) generated in the coil is stored in the secondary cell (the rechargeable battery) 108, and is then used as the energy for driving the watch and the energy for driving the variety of sensors.

As described above, in the power supply section 106, there is used the power generation system for generating the power using the solar light as natural energy easy for the user to obtain, or using the motion of the arm of the user (wearer), and therefore, it is possible to use so-called clean energy having no influence on the environment as the power source (power supply). Further, it is possible to generate enough power for the power consumption of the electronic watch W with sensors by the self-power generation using the power supply section 106 provided with the self-power generation function, and it is possible to install the function such as the GPS relatively high in power consumption, the plurality of sensors, and so on.

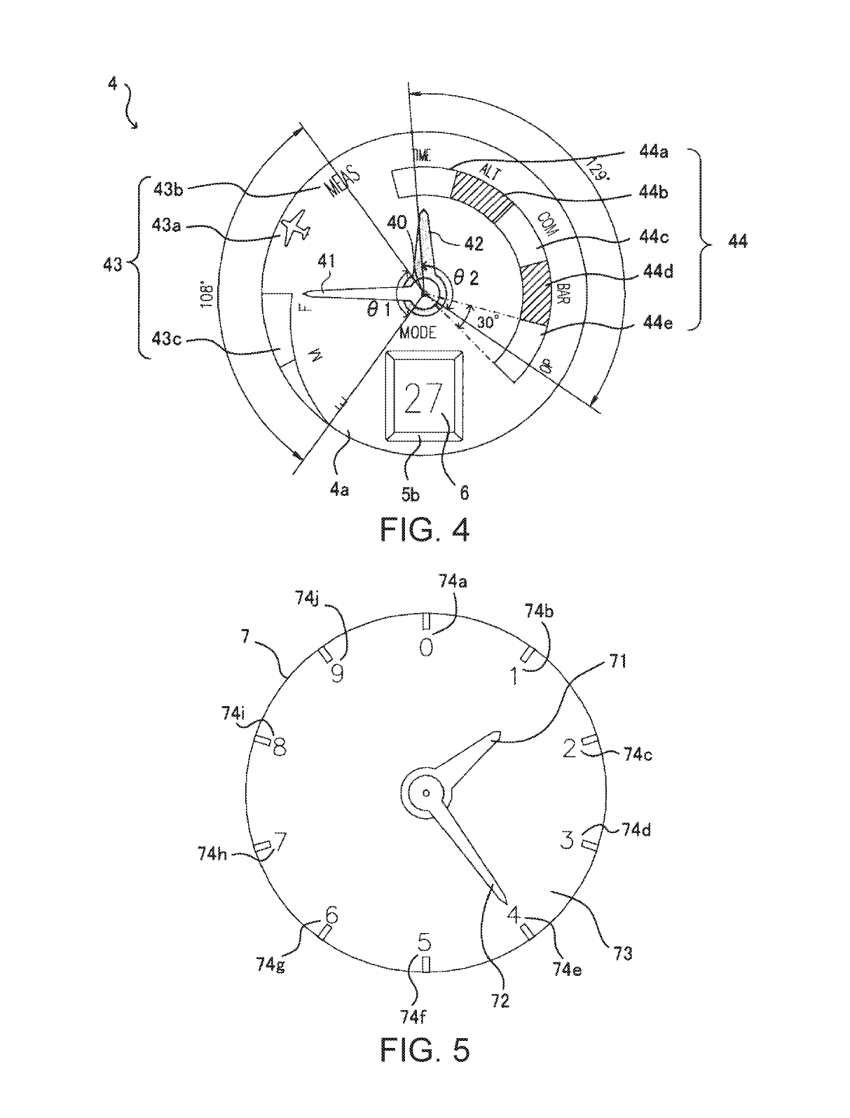

Then, a detailed configuration and operations of the electronic watch W with sensors will be described with reference to FIG. 3, FIG. 4, and FIG. 5. It should be noted that FIG. 4 is a plan view showing the six-o'clock information display section, which is a small window (small window section) having a circular shape disposed on a six-o'clock side of the electronic watch with sensors shown in FIG. 3, in an enlarged manner. FIG. 5 is a plan view showing the two-o'clock information display section, which is a small window (small window section) having a circular shape disposed on a two-o'clock side of the electronic watch with sensors shown in FIG. 3, in an enlarged manner.

As shown in FIG. 3, the electronic watch W with sensors receives the radio wave including the time information, and then corrects the display time based on the time information. The electronic watch W with sensors is provided with the display section 5 including the dial plate 10 and disposed on the inner circumferential side of a dial ring 17 constituting the apparatus main body 100, and the bezel 19 disposed concentrically with the dial ring 17 on the outer circumferential side of the dial ring 17. To the display section 5, there are attached the indicating hand (the hour hand) 1 and the indicating hand (the minute hand) 2 as central hands, and the measurement indicating hand 33 as the indicating hand. Further, at the positions corresponding to the indicating hand (the hour hand) 1 of the display section 5, there are formed scale marks 5a in the 12-hour clock to form a ring-like shape.

Further, in the direction indicating the 10 o'clock of the display section 5, there is formed the ten-o'clock information display section 3, which is a small window section having a circular shape, and to which the indicating hand (the second hand) 34 as an auxiliary hand is attached. Further, in the direction indicating the 6 o'clock of the display section 5, there is formed the six-o'clock information display section 4, which is a small window section having a circular shape, and to which the indicating hand (the first indicating hand) 42 and the indicating hand (the second indicating hand) 41 are attached. Further, in the direction indicating the 2 o'clock of the display section 5, there is formed the two-o'clock information display section 7, which is a small window section having a circular shape, and to which the indicating hands (the measurement indicating hands) 71, 72 are attached.

As described above, in the present embodiment, there is described the example in which there are provided three circular small window sections, namely the ten-o'clock information display section 3, the six-o'clock information display section 4, and the two-o'clock information display section 7, but the number of the small window sections is not limited to this example. The number of the small window sections to be disposed is preferably in a range of not smaller than 1 and not larger than 4. Further, the positions where the small window sections are disposed are not limited to the positions shown in the drawing, but the small window sections can be disposed at any positions. Further, the shape of each of the small window sections is not limited to the circular shape, but can also be other shapes.

This is because, by disposing one or more small window sections, the information of each of the operation modes detected by the sensors can be displayed using the small window sections in an easy-to-understand manner. Further, by disposing a plurality of small window sections, it is possible to display the information of the operation modes detected by the plurality of sensors in the respective small window sections different from each other, and thus, the variety of types of information can be displayed in an easier-to-understand manner. Further, by setting the number of the small window sections not larger than 4, it is possible to set the size of the small window sections to an appropriate size good in visibility. In other words, if the number of the small window sections is 5 or more, each of the small window sections becomes small in size in the limited space of the display section, the visibility of the information displayed thereon degrades, and it becomes difficult to visually recognize the information at a glance.

As shown in FIG. 4, the six-o'clock information display section 4 of the electronic watch W with sensors has a plurality of display modes, namely a time display mode (TIME) for displaying the time, an altitude display mode (ALT) for displaying the altitude, an atmospheric pressure display mode (BAR) for displaying the atmospheric pressure, an orientation display mode (COM) for displaying the orientation, and an option display mode (OP) for displaying other indexes. Here, the option display mode is a mode for displaying other indexes such as biological information or a moving amount (an amount of exercise).

Further, in the time display mode (TIME), it is possible to perform the time display using the time display function, a dual time function capable of displaying two or more times, and so on. Further, in the time display mode (TIME), a chronograph function (a stopwatch function) becomes available in addition to the time display. Since such functions of the time display are provided, it becomes possible to provide a variety of types of timepiece (time measurement) information the user desires.

It should be noted that the option display mode is defined as the mode in which the other sensor apparatus C such as a pulse sensor for measuring the biological information is connected to the electronic watch W with sensors wirelessly or with wire, and the biological information measured by the sensor apparatus C is displayed on the electronic watch W with sensors as shown in FIG. 17. It should be noted that the option display mode is not limited to such a mode for displaying the biological information, but can arbitrarily be changed to other modes (other indexes) using the other sensor apparatus C provided with an acceleration sensor for detecting second physical information such as exercise information or energy consumption information. As described above, it is possible to detect the information which cannot be detected by the electronic watch W with sensors, namely the second physical information such as the exercise information or the energy consumption information, the biological information, and so on, using the other sensor apparatus C, and then display the information on the display section 5 of the electronic watch W with sensors. Thus, even the electronic watch W with sensors limited in space for mounting on the wrist becomes capable of obtaining a variety of types of information, and can improve the usability.

The display mode showing which one of the operation modes is displayed out of the location information and the locomotion information (the information of the physical quantities) of the user is switched in accordance with the switching of the areas indicated by the indicating hand 42 in the six-o'clock information display section 4 as shown in FIG. 3. As described above, in at least one of the small window sections, there is disposed the mode display section corresponding to each of the operation modes out of the location information and the locomotion information (the information of the physical quantities) of the user as the operation modes for performing the operations corresponding respectively to the plurality of sensors. By showing which one of the operation modes corresponds to the information in the mode display section formed of the small window section, it is possible to easily identify the information in which one of the operation modes is displayed out of the plurality of pieces of information.

The display mode is controlled by the control section 110. The control section 110 switches the display mode in accordance with, for example, the holding down operation of the user to the button 14.

The six-o'clock information display section 4 displays the display modes (the time display mode, the altitude display mode, the atmospheric pressure display mode, the orientation display mode, and option display mode) with the indicating hand (the first indicating hand) 42, and displays the remaining battery level and so on with the indicating hand (the second indicating hand) 41.

In the time display mode, the time is displayed with the indicating hand (the hour hand) 1, the indicating hand (the minute hand) 2, and the indicating hand (the second hand) 34 of the ten-o'clock information display section 3. Specifically, in the case in which the indicating hand (the first indicating hand) 42 in the six-o'clock information display section 4 indicates the “TIME” area 44a (in the case in which the display mode is set to the time display mode), the time is displayed with the indicating hand (the hour hand) 1, the indicating hand (the minute hand) 2, and the indicating hand (the second hand) 34 of the ten-o'clock information display section 3. It should be noted that the indicating hand (the hour hand) 1 and the indicating hand (the minute hand) 2 show the time (the hour and the minute) in any display modes even other than the time display mode.

It should be noted that in the display section 4a of the six-o'clock information display section 4, there are disposed the letters 43b of “MEAS” representing that “the measurement is in process,” and a remaining battery level meter 43c for indicating the remaining amount of the secondary cell 108 as the power source of the electronic watch W with sensors as shown in FIG. 4.

As shown in FIG. 4, in the six-o'clock information display section 4, the “ALT” area 44b corresponding to the altitude display mode, the “COM” area 44c corresponding to the orientation display mode, and the “BAR” area 44d corresponding to the atmospheric pressure display mode are arranged side by side in the order of the “ALT” area 44b, the “COM” area 44c, and the “BAR” area 44d.

Further, on the opposite side of the “ALT” area 44b to the “COM” area 44c side, there is disposed the area (the “TIME” area) 44a corresponding to the time display mode. On the opposite side of the “BAR” area 44d to the “COM” area 44c side, there is disposed the area (the “OP” area) 44e corresponding to the option display mode.

The indicating hand 42 indicates the “TIME” area 44a to thereby display the fact that the display mode is set to the time display mode. The indicating hand 42 indicates the “ALT” area 44b to thereby display the fact that the display mode is set to the altitude display mode. The indicating hand 42 indicates the “COM” area 44c to thereby display the fact that the display mode is set to the orientation display mode. The indicating hand 42 indicates the “BAR” area 44d to thereby display the fact that the display mode is set to the atmospheric pressure display mode. The indicating hand 42 indicates the “OP” area 44e to thereby display the fact that the display mode is set to the option display mode. Further, in the rotational direction (circling direction) of the indicating hand 42, the distance between the “ALT” area 44b and the “COM” area 44c is made shorter than the distance between the “ALT” area 44b and the “BAR” area 44d, and at the same time, the distance between the “COM” area 44c and the “BAR” area 44d is made shorter than the distance between the “ALT” area 44b and the “BAR” area 44d.

The areas corresponding respectively to the display modes are disposed taking the usage scene into consideration. In the daily life, in general, the time display mode is high in use frequency. Therefore, the “TIME” area 44a (corresponding to the time display mode) is disposed at the position of twelve o'clock the easiest to visually recognize.

Further, in the usage scene in outdoor activities such as mountaineering, there is a high possibility that the altitude display mode and the orientation display mode are used. Therefore, the “ALT” area 44b (corresponding to the altitude display mode) and the “COM” area 44c (corresponding to the orientation display mode) high in possibility of being indicated by the indicating hand 42 in the usage scene in the outdoor activities such as mountaineering are disposed in this order contiguously to the “TIME” area 44a.

It should be noted that the orientation display mode (corresponding to the “COM” area 44c) is high in possibility of being used in the usage scene in marine sports such as sailing of a yacht besides the usage scene in the outdoor activities such as mountaineering. Further, in the usage scene in the marine sports such as sailing of a yacht, there is a high possibility that the atmospheric pressure display mode (corresponding to the “BAR” area 44d) is used similarly to the orientation display mode (corresponding to the “COM” area 44c). Therefore, the “BAR” area 44d (corresponding to the atmospheric pressure display mode) is disposed adjacent to the “COM” area 44c.

As described above, the distance (e.g., the distance between the “ALT” area 44b and the “COM” area 44c, and the distance between the “COM” area 44c and the “BAR” area 44d) between the areas high in possibility of being used in the same usage scene is shorter than the distance (e.g., the distance between the “ALT” area 44b and the “BAR” area 44d) between the areas low in possibility of being used in the same usage scene. Therefore, it is possible to make the switching time of the indicating position of the indicating hand 42 between the areas high in possibility of being indicated in the same usage scene shorter than the switching time of the indicating position of the indicating hand 42 between the areas low in possibility of being indicated in the same usage scene. Therefore, it becomes possible to prevent that it takes too much time to switch the indicating position of the indicating hand 42 in the same usage scene.

The altitude in the altitude display mode, the atmospheric pressure in the atmospheric pressure display mode, and the pulse rate in the option display mode are displayed with the two-o'clock information display section 7 having a circular shape located on the two-o'clock side of the electronic watch W with sensors shown in FIG. 3, the scale marks dividing the dial ring 17 having a ring-like shape into 100 equal parts, and the measurement indicating hand 33.

Specifically, in the two-o'clock information display section 7, the measurement indicating hand 71 displays the thousands digit of the measurement value (e.g., the altitude, the atmospheric pressure, or the pulse rate), and the measurement indicating hand 72 displays the hundreds digit of the measurement value. The measurement indicating hand 33 displays the tens digit and the ones digit of the measurement value using the scale marks (division into 100 equal parts) of the dial ring 17. For example, in the case in which the indicating hand 42 in the six-o'clock information display section 4 indicates the “ALT” area 44b, the two-o'clock information display section 7 and the measurement indicating hand 33 display the measurement value of the altitude. Further, in the case in which the indicating hand 42 in the six-o'clock information display section 4 indicates the “BAR” area 44d, the two-o'clock information display section 7 and the measurement indicating hand 33 display the measurement value of the atmospheric pressure.

The north orientation, for example, in the orientation display mode is displayed by the measurement indicating hand 33 indicating the north direction. Specifically, in the case in which the indicating hand 42 in the six-o'clock information display section 4 indicates the “COM” area 44c, the measurement indicating hand 33 displays the north direction. On this occasion, in the two-o'clock information display section 7, the measurement indicating hands 71, 72 indicate the scale mark 74a (i.e., value of “0”).

The time in the time display mode is displayed by the indicating hand (the hour hand) 1 representing the hour, the indicating hand (the minute hand) 2 representing the minute, and the indicating hand (the second hand) 34 of the ten-o'clock information display section 3, which is the small window section having a circular shape located on the ten-o'clock side, and represents the second. Specifically, in the case in which the indicating hand 42 in the six-o'clock information display section 4 indicates the “TIME” area 44a, the time is displayed with the indicating hand (the hour hand) 1, the indicating hand (the minute hand) 2, and the indicating hand (the second hand) 34 of the ten-o'clock information display section 3. It should be noted that the indicating hand (the hour hand) 1 and the indicating hand (the minute hand) 2 also show the time (the hour and the minute) in any other display modes. Here, a supplemental explanation on FIG. 3 and FIG. 4 will be presented. FIG. 3 is a diagram showing the electronic watch W with sensors in the case in which the display mode is set to the altitude display mode (“ALT”), and FIG. 4 is a diagram showing the six-o'clock information display section 4 in the case in which the display mode is set to the time display mode (“TIME”).

To the display section 5, there is attached the measurement indicating hand 33. For example, in the altitude display mode, the measurement indicating hand 33 displays a value in a range of 0 through 99 corresponding to the value of the altitude calculated based on the output from the atmospheric pressure sensor as the measurement result. Specifically, the measurement indicating hand 33 displays the ones digit and the tens digit of the measurement result of the altitude using the scale marks formed on the dial ring 17 in the outer circumferential part of the display section 5 so as to divide the dial ring 17 into 100 equal parts. In the direction pointing to the two o'clock of the display section 5, there is formed the two-o'clock information display section to which the measurement indicating hands 71, 72 for displaying the thousands digit and the hundreds digit of the measurement result of the altitude are attached. In the example shown in the drawings, the measurement indicating hands 71, 72 show the altitude of 1400 m, and the measurement indicating hand 33 shows the altitude of 65 m. Thus, it is possible for the user to know the fact that the altitude is 1465 m.

The indicating hands 42, 41 are attached to the six-o'clock information display section 4 disposed in the direction pointing to the six o'clock of the display section 5, wherein the indicating hand 42 displays first information and the indicating hand 41 displays second information. Here, each of the first information and the second information is information other than the time.

As shown in detail in FIG. 4, the display section 4a of the six-o'clock information display section 4 includes a first display area 44 and a second display area 43. The first display area 44 and the second display area 43 are arranged side by side so as not to overlap each other. The second display area 43 is a range having a sector shape centered on the concentric axis 40 and having a central angle θ1 (108°). The second display area 43 is an example of an area which can be indicated by the indicating hand 41. The first display area 44 is a range having a circular arc shape centered on the concentric axis 40 and having a central angle θ2 (129°). The first display area 44 is an example of an area which can be indicated by the indicating hand 42. The first display area 44 and the second display area 43 are divided into two or more display units with the rotational angles around the concentric axis 40.

In the second display area 43, there are disposed an area (the remaining battery level meter 43c) showing the remaining battery level, and an area (an icon 43a, and letters 43b) showing the operation state of the electronic watch W with sensors. The indicating hand 42 indicates the area for showing the remaining battery level to thereby display the remaining battery level. Further, the indicating hand 42 indicates the area for showing the operation state of the electronic watch W with sensors to thereby display the operation state of the electronic watch W with sensors. The operation state of the electronic watch W with sensors includes “wireless communication is suspended” denoting the suspension of the reception of the radio wave including the time information, and “measurement is in process” denoting the fact that the given measurement (e.g., measurement of the time, the altitude, the orientation, or the atmospheric pressure) corresponding to the display mode displayed by the indicating hand 42 is in process.

In the present embodiment, in the second display area 43, there are disposed the remaining battery level meter 43c, the icon 43a representing that the wireless communication is suspended, and letters 43b of “MEAS” representing “measurement is in process.” The area where the letters 43b of “MEAS” are located is adjacent to the first display area 44.

The indicating hand 41 rotates around the concentric axis 40 in the second display area 43 to thereby selectively display either one of the remaining battery level and the operation state of the electronic watch W with sensors. On the other hand, the indicating hand 42 rotates around the concentric axis 40 in the first display area 44 to thereby display the current display mode (either one of the time display mode, the altitude display mode, the orientation display mode, the atmospheric pressure display mode, and the option display mode). It should be noted that each of the display modes also represents the type of the measurement value in the present display mode. For example, the time display mode represents the time as the type of the measurement value, the altitude display mode represents the altitude as the type of the measurement value, the orientation display mode represents the orientation as the type of the measurement value, the atmospheric pressure display mode represents the atmospheric pressure as the type of the measurement value, and the option display mode represents the biological information as the type of the measurement value.

The indicating hand 42 is driven by a reduction mechanism for reducing the rotation of the indicating hand 41 to rotate the indicating hand 42. The indicating hand 41 moves in a range of 108° from the “MEAS” position to the “E” position (an empty position) while moving from the “F” position (a full position) as a central point in a range of ±54° to thereby display the second information (the remaining battery level and the operation state of the electronic watch W with sensors).

In the case in which the indicating hand 41 moves the range of 108° from the “MEAS” position to the “E” position, the indicating hand 42 moves the display position in a range of 4.5° due to the reduction mechanism described above. Here, the display units (the “TIME” area, the “ALT” area, the “COM” area, the “BAR” area, and the “OP” area) 44a through 44e of the display modes are each a range of an angle of 30° (=0±15°). Therefore, even if the indicating hand 42 rotates in the range of 4.5° due to the rotation of the indicating hand 41, the area (the display unit) indicated by the indicating hand 42 is not changed, and it is possible to lower the possibility that the user erroneously reads the display mode indicated by the indicating hand 42. The angle of 30° (=0±15°) is an example of an angle dθ. It should be noted that it is arranged that the indicating hand 41 indicates the icon 43a representing that the wireless communication is suspended if the user operates either one of the buttons 13 through 15 in the case in which the wireless communication function (the reception function of the radio wave including the time information) is unavailable such as the case in which the user wearing the electronic watch W with sensors is aboard an airplane.

The first display area 44 includes the “TIME” area 44a, the “ALT” area 44b, the “COM” area 44c, the “BAR” area 44d, and the “OP” area 44e. In the first display area 44, the indicating hand 42 selectively indicates either one of the display units (the “TIME” area, the “ALT” area, the “COM.” area, the “BAR” area, and the “OP” area) 44a through 44e of the display modes to thereby display the current display mode.

In the present embodiment, the display units 44a through 44e of the respective display modes are represented by the letters described in an area shaped like a circular arc strip. Specifically, as the display units 44a through 44e, there are shown “TIME” (the time), “ALT” (the altitude), “COM” (a compass; the orientation), “BAR” (the atmospheric pressure), and “OP” (the option).

The display mode displayed by the indicating position of the indicating hand 42, namely the display mode displayed in the first display area 44, can be switched by a holding down operation of the button 14. For example, every time the button 14 is held down once, the indicating hand 41 rotates 360° clockwise, and at the same time, the indicating hand 42 rotates 30° clockwise, which is an example of the angle de. Therefore, every time the button 14 is held down once, the display mode is switched from the time display mode (“TIME” mode) to the altitude display mode (“ALT” mode), the orientation display mode (“COM” mode), the atmospheric pressure display mode (“BAR” mode), and the option display mode (“OP” mode) in sequence.

Further, if the button 14 is held down in the situation in which the indicating hand 42 indicates the option display mode (“OP” mode), the indicating hand 42 reverses to move to the “TIME” area 44a (the area of the time display mode). It should be noted that in the example shown in FIG. 4, the indicating hand 41 indicates the remaining battery level “F” (full), and the indicating hand 42 indicates the time display mode.

In the direction pointing to the six o'clock of the display section 4a of the six-o'clock information display section 4, there is formed an information display section 5b for seeing a day wheel 6 for displaying the calendar through the dial. The information display section 5b is an example of being fixedly disposed on the straight line passing through the concentric axis 40 and connecting the twelve-o'clock side and the six-o'clock side to each other in an area not overlapping the first display area 44 and the second display area 43. The information display section 5b displays the date of the calendar. By fixedly disposing the information display section 5b on the straight line passing through the concentric axis 40 and connecting the twelve-o'clock side and the six-o'clock side to each other, the symmetric design of the whole of the electronic watch W with sensors is realized. It should be noted that the day wheel 6 is a display member having a ring-like shape with numerals of dates described, and performs a rotational operation due to a drive system not shown.

FIG. 4 is a diagram showing the rotational range of the indicating hand 41 and the rotational range of the indicating hand 42 coordinating with the indicating hand 41. In the example shown in FIG. 4, the indicating hand 42 indicates the display unit 44a (the “TIME” area). In the case in which the indicating hand 42 indicates the display unit 44a, the display mode is set to the time display mode. In the time display mode, the chronograph function (the stopwatch function) becomes available in addition to the time display.

When the button 13 is held down in the state shown in FIG. 4, the measurement indicating hand 33 shown in FIG. 3 starts hand driving by ⅕ second, and at the same time, the indicating hand 41 of the six-o'clock information display section 4 rotates 54° clockwise from the position indicating the remaining battery level “F” to come to the position indicating the letters 43b of “MEAS” denoting that the measurement is in process as shown in FIG. 4. On this occasion, the indicating hand 42 rotates 4.5° clockwise coordinating with the rotation of the indicating hand 41. Here, the display unit 44a of the “TIME” area has the width of 30°. Therefore, the indicating hand 42 still indicates the display unit 44a of the “TIME” area as a result. Similarly, in the case in which the indicating hand 41 rotates 54° counterclockwise from the position indicating the remaining battery level “F” to indicate the remaining battery level “E,” the indicating hand 42 rotates 4.5° counterclockwise, but still indicates the display unit 44a of the “TIME” area as a result.

The two-o'clock information display section 7 shown in FIG. 5 displays the altitude in the altitude display mode, the atmospheric pressure in the atmospheric pressure mode, the pulse rate in the option display mode, and the time in the stopwatch function with the scale marks 74a through 74j, the measurement indicating hand 71 and the measurement indicating hand 72 in cooperation with the measurement indicating hand 33. The dial plate 73 constituting the two-o'clock information display section 7 is an example of a member provided with the scale marks 74a through 74j expressed by the numerical values. In the configuration example shown in FIG. 5, the scale marks 74a through 74j are expressed by the numerical values “0” through “9,” respectively.

The control section 110 displays the physical quantities (e.g., the measurement value of the altitude, the measurement value of the atmospheric pressure, the measurement value of the pulse rate, and measurement value of the time in the stopwatch function) expressed with the numerical values using the measurement indicating hands 71, 72 and the scale marks 74a through 74j. On this occasion, the control section 110 uses the numerical values of the scale marks 74a through 74j as values obtained by multiplying the numerical values of the scale marks 74a through 74j by 10ⁿ (n denotes an integer equal to or larger than 0). Here, each of the measurement value of the altitude, the measurement value of the atmospheric pressure, and the measurement value of the pulse rate is an example of the physical quantity (physical quantity A) expressed by the numerical value. In contrast, the measurement value of the time in the stopwatch function is an example of a physical quantity (physical quantity B) different in type from the physical quantity A expressed by the numerical value.

As the value n described above, the control section 110 uses a value different between the case of displaying the physical quantity A using the measurement indicating hands 71, and the scale marks 74a through 74j, and the case of displaying the physical quantity B using the measurement indicating hands 71, 72 and the scale marks 74a through 74j.

In the present embodiment, in the case of displaying the physical quantity A, regarding the combination of the measurement indicating hand 71 and the scale marks 74a through 74j, the control section 110 uses the numerical value (e.g., “2”) of the scale marks 74a through 74j as a value (“2000”) obtained by multiplying the numerical value (“2”) by 10^{3 (=n)} (=1000). In this case, the control section 110 uses “3” as the value n described above.

In contrast, in the case of displaying the physical quantity B, regarding the combination of the measurement indicating hand 71 and the scale marks 74a through 74j, the control section 110 uses the numerical value (e.g., “2”) of the scale marks 74a through 74j as a value (“20”) obtained by multiplying the numerical value (“2”) by 10^{1 (=n)}(=10). In this case, the control section 110 uses “1” as the value n described above.

Further, in the case of displaying the physical quantity A, regarding the combination of the measurement indicating hand 72 and the scale marks 74a through 74j, the control section 110 uses the numerical value (e.g., “2”) of the scale marks 74a through 74j as a value (“200”) obtained by multiplying the numerical value (“2”) by 10^{2 (=n)} (=100). In this case, the control section 110 uses “2” as the value n described above.

In contrast, in the case of displaying the physical quantity B, regarding the combination of the measurement indicating hand 72 and the scale marks 74a through 74j, the control section 110 uses the numerical value (e.g., “2”) of the scale marks 74a through 74j as a value (“2”) obtained by multiplying the numerical value (“2”) by 10^{0 (=n)} (=1). In this case, the control section 110 uses “0” as the value n described above.

Therefore, in the case in which the physical quantity A (either one of the measurement value of the altitude, the measurement value of the atmospheric pressure, and the measurement value of the pulse rate) is displayed, the thousands digit of the physical quantity A is displayed by the measurement indicating hand 71, and the hundreds digit of the physical quantity A is displayed by the measurement indicating hand 72. It should be noted that regarding the tens digit and the ones digit of the physical quantity A, the control section 110 drives the stepping motor (not shown) for driving the measurement indicating hand 33 to thereby display the tens digit and the ones digit of the physical quantity A using the measurement indicating hand 33 and the scale marks (division into 100 equal parts) provided to the dial ring 17 so as to divide the dial ring 17 into 100 equal parts.

In contrast, in the case in which the physical quantity B (the measurement value of the time in the stopwatch function) is displayed, the tens digit of the minute in the physical quantity B is displayed by the measurement indicating hand 71, and the ones digit of the minute in the physical quantity B is displayed by the measurement indicating hand 72. It should be noted that regarding the value of the second in the physical quantity B, the control section 110 drives the step motor (not shown) for driving the measurement indicating hand 33 to thereby display the value of the second in the physical quantity B using the measurement indicating hand 33 and the 12-hour clock scale marks 5a provided to the display section 5. On this occasion, the control section 110 makes the hand driving of the measurement indicating hand 33 by ⅕ second and makes the measurement indicating hand 33 make one revolution.

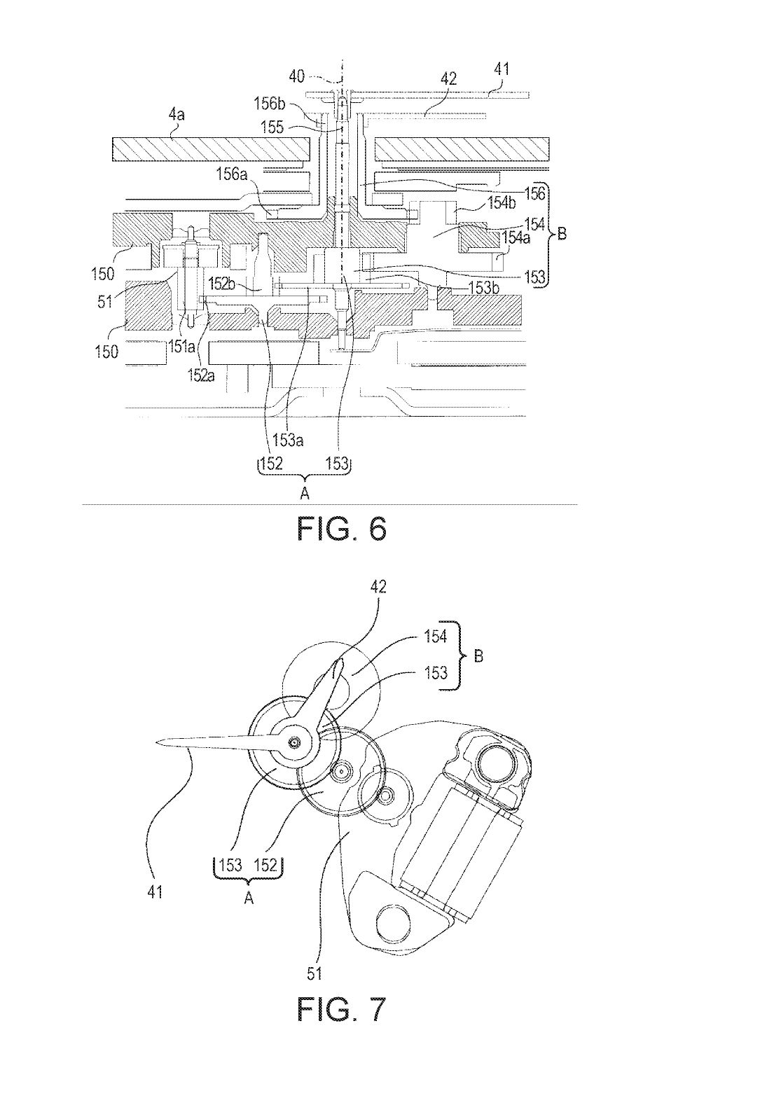

The drive system of the indicating hand described above will be described with reference to FIG. 6 and FIG. 7. FIG. 6 is a cross-sectional view showing a configuration of the six-o'clock information display section 4 according to the present embodiment, and FIG. 7 is a plan view of the drive system and so on shown in FIG. 6. It should be noted that FIG. 6 and FIG. 7 illustrate the drive system of the indicating hand 42 and the indicating hand 41.

As shown in FIG. 6 and FIG. 7, the indicating hand 42 and the indicating hand 41 are driven by the stepping motor 51 common to the indicating hand 42 and the indicating hand 41, and rotate concentrically via an intermediate wheel 152 or an intermediate wheel 154. The electronic watch W with sensors is provided with a power transmission mechanism A for rotating the indicating hand 41 at a first speed due to the drive force from the stepping motor 51 as the drive source, and a reduction mechanism B for reducing the rotation of the indicating hand 41 to rotate the indicating hand 42 at a second speed. The stepping motor 51 has the drive section constituted by the power transmission mechanism A and the reduction mechanism B. The power transmission mechanism A and the reduction mechanism B use the stepping motor 51 as a common drive source. Some of the gear wheels and so on are used commonly to the power transmission mechanism A and the reduction mechanism B. Specifically, the power transmission mechanism A includes the intermediate wheel 152 and a remaining battery level display wheel 153, and the reduction mechanism B includes the remaining battery level display wheel 153, the intermediate wheel 154, and a mode display wheel 156. The remaining battery level display wheel 153 rotates so that the indicating hand 41 can selectively indicate either one of the icon 43a (see FIG. 4) denoting that the wireless communication is suspended, and the letters 43b (see FIG. 4) of “MEAS” representing that the measurement is in process in addition to the remaining battery level meter 43c (see FIG. 4).

In detail, the stepping motor 51 is a drive source for driving the indicating hand 42 and the indicating hand 41. The stepping motor 51 is provided with a coil block, a stator, and a rotor 151a. The stepping motor 51 rotates if a drive pulse is supplied. The coil block is configured including a magnetic core formed of a high-magnetic permeability material, a coil wound around the magnetic core, a coil lead board in which the both ends of the coil are processed so as to be able to electrically be connected, and a coil frame. The stator is formed of a high-magnetic permeability material similarly to the magnetic core. In the rotor 151a, a pinion made of metal is attached to a rotor magnet. As a power source of the drive source such as the stepping motor 51, there is used, for example, the secondary cell 108, and it is arranged that a direct-current voltage of 3V is applied.

Further, the stepping motor 51 rotates due to the drive pulses output from the control section 110 such as a CPU-IC. The CPU-IC is an arithmetic processing device for controlling the operation of the whole of the electronic watch W with sensors. The CPU-IC receives the operations of the buttons 13 through 15 by the user, and at the same time is connected to the acceleration sensor 101, the pressure sensor 102, the orientation sensor 103, the communication section 104, and the receiving section 105. The CPU-IC also functions as a remaining level measurement section for measuring the remaining battery level, and a display mode control section for controlling the display mode. Further, the CPU-IC outputs the drive pulses of the stepping motor 51 in accordance with the operation of the user to perform the control of the displays in the six-o'clock information display section 4.

The control section 110 drives the stepping motor 51 to thereby drive the indicating hand 42 and the indicating hand 41. Further, the control section 110 drives each of the indicating hand (the hour hand) 1, the indicating hand (the minute hand) 2, the indicating hand (the second hand) 34, the day wheel 6, and the measurement indicating hands 33, 71, and 72 via drive mechanism not shown in order to display the measurement values of the acceleration sensor 101, the pressure sensor 102, and the orientation sensor 103, the second physical information such as the biological information obtained by the communication section 104, and the internal time corrected using the time information obtained using the receiving section 105.

As shown in FIG. 6, the rotor 151a of the stepping motor 51 is meshed with a lower gear wheel 152a of the intermediate wheel 152, and rotates a lower gear wheel 153a of the remaining battery level display wheel 153 via an upper gear wheel 152b rotating integrally with the lower gear wheel 152a. The remaining battery level display wheel 153 rotates integrally with a rotary shaft 155. The rotary shaft 155 rotates around the concentric axis 40 described above. By the rotary shaft 155 rotating around the concentric axis 40 via the remaining battery level display wheel 153, hand driving of the indicating hand 41 is performed.

Further, an upper gear wheel 153b of the remaining battery level display wheel 153 rotates integrally with the lower gear wheel 153a. The remaining battery level display wheel 153 rotates a lower gear wheel 154a of the intermediate wheel 154 via the upper gear wheel 153b. The lower gear wheel 154a of the intermediate wheel 154 rotates integrally with the an upper gear wheel 154b disposed on the obverse side (the display section 4a side) of a main plate 150. The intermediate wheel 154 rotates a gear wheel 156a of the mode display wheel 156 via the upper gear wheel 154b. The mode display wheel 156 has a hollow cylindrical part 156b. The cylindrical part 156b is fitted on the outer circumferential surface side of the rotary shaft 155. The cylindrical part 156b rotates around the concentric axis 40 similarly to the rotary shaft 155. Due to the rotation of the cylindrical part 156b, hand driving of the indicating hand 42 is performed.

The first display area 44 is divided by the rotational angle dθ in the concentric axis 40 into a plurality of display units (see FIG. 4). The angle dθ is set so that Formula 1 is fulfilled assuming the reduction ratio of the reduction mechanism B as 1/N.

dθ>θ1/N Formula 1

In the present embodiment, the angle dθ is set to 30°. In detail, regarding the indicating hand 41, the reduction ratio of the gear wheels in the power transmission mechanism A is set so that the indicating hand 41 makes one revolution (rotates 360°) while the stepping motor 51 makes 40 steps. Therefore, the indicating hand 41 performs the hand driving by the angle obtained by dividing 360° by 40. On the other hand, regarding the indicating hand 42, the reduction ratio of the reduction mechanism B is set so that the indicating hand 42 rotates 30°, which corresponds to one display unit, while the indicating hand 41 makes one revolution. When the button 14 is held down once, the indicating hand 41 makes one revolution (360°) and the indicating hand 42 proceeds as much as a unit scale mark (one display unit)(30°) to switch the display mode.

The reason that the reduction ratio 1/N of the reduction mechanism B, the angle θ1 of the maximum range in which the indicating hand 41 swings, and the angle dθ of one display unit in the first display area 44 are determined as expressed by Formula 1 is as follows.

The maximum range in which the indicating hand 41 swings is the angle θ1. Since the reduction ratio of the reduction mechanism B is 1/N, when the indicating hand 41 rotates as much as a predetermined angle, the indicating hand 42 rotates as much as 1/N of the predetermined angle. Therefore, even if the indicating hand 41 rotates as much as the angle θ1, the indicating hand 42 only rotates as much as the angle θ1/N as a result. Here, dθ>θ1/N is true, if the indicating hand 41 rotates as much as the angle θ1, the swing angle of the indicating hand 42 is smaller than the angle dθ of the display unit in the first display area 44. Therefore, it is possible to reduce the possibility that the information (the display mode) indicated by the indicating hand 42 is erroneously read in the case in which the information indicated by the indicating hand 41 is changed.

It should be noted that it is also possible for the angle dθ to be set so as to fulfill the relationship of Formula 2 instead of Formula 1.

dθ/2>θ1/N Formula 2

In this case, if the indicating hand 41 rotates as much as the angle θ1, the indicating hand 42 rotates as much as an angle θ1/N, but the angle θ1/N is smaller than a half of the angle dθ of the display unit in the first display area 44. Therefore, it is possible to further reduce the influence of the rotation of the indicating hand 41 on the indicating hand 42.

According to the electronic watch W with sensors according to the present embodiment described hereinabove, in the six-o'clock information display section 4, the “ALT” area 44b, the “COM” area 44c, and the “BAR” area 44d are arranged side by side in the order of the “ALT” area 44b, the “COM” area 44c, and the “BAR” area 44d. Further, in the rotational direction (circling direction) of the indicating hand 42, the distance between the “ALT” area 44b and the “COM” area 44c is made shorter than the distance between the “ALT” area 44b and the “BAR” area 44d, and at the same time, the distance between the “COM” area 44c and the “BAR” area 44d is made shorter than the distance between the “ALT” area 44b and the “BAR” area 44d.

The user changes the indicating area of the indicating hand 42 in accordance with the usage scene to thereby switch between the altitude display mode, the orientation display mode, and the atmospheric pressure display mode as a result. For example, in the usage scene in outdoor activities such as mountaineering, there is a high possibility that the altitude display mode and the orientation display mode are used. Further, in the usage scene in the marine sports such as yacht racing, there is a high possibility that the atmospheric pressure display mode and the orientation display mode are used. In the present embodiment, the distance (e.g., the distance between the “ALT” area 44b and the “COM” area 44c, which is high in possibility of being used together in the usage scene of mountaineering, and the distance between the “COM” area 44c and the “BAR” area 44d, which is high in possibility of being used together in the usage scene of sailing of a yacht) between the areas high in possibility of being used in the same usage scene is shorter than the distance (e.g., the distance between the “ALT” area 44b and the “BAR” area 44d) between the areas low in possibility of being used in the same usage scene. Therefore, it becomes possible to prevent that it takes too much time to switch the indicating position of the indicating hand 42 in the same usage scene.

Further, there is a possibility that when figuring out the state of the electronic watch W with sensors, the user visually recognizes the indicating position of the indicating hand 41 to check the operation state of the electronic watch W with sensors and the remaining battery level, and at the same time visually recognizes the indicating position of the indicating hand 42 to check the current display mode. In the present embodiment, the first display area 44 indicated by the indicating hand 42 and the second display area 43 indicated by the indicating hand 41 are adjacent to each other. Therefore, it becomes possible for the user to visually recognize the display mode displayed by the indicating hand 42 and the operation state and the remaining battery level displayed by the indicating hand 41 in a lump when figuring out the state of the electronic watch W with sensors, which lowers the necessity of moving the eyes widely. Therefore, it becomes possible to obtain high visibility with respect to the display content of the indicating hand 42 and the display content of the indicating hand 41.

In the present embodiment, the indicating hand 42 and the indicating hand 41 rotate concentrically. Therefore, it becomes possible to achieve space saving compared to the case in which the indicating hand 42 and the indicating hand 41 rotate around respective axes different from each other.

In the present embodiment, the operation state displayed by the indicating hand 41 includes an in-measurement state denoting that the measurement corresponding to the display mode displayed by the indicating hand 42 is in process. Further, the area of the letters 43b of “MEAS” corresponding to the in-measurement state is adjacent to the first display area 44 indicated by the indicating hand 42. Therefore, it becomes possible for the user to visually recognize the display mode indicated by the indicating hand 42, and the display related to whether the measurement corresponding to the display mode is in process correlated with each other in a lump.

In the present embodiment, the icon 43a representing that the wireless communication is suspended is disposed adjacent to “F” (full) in the remaining battery level meter 43c representing the remaining battery level of the secondary cell 108. Receiving (wireless communication) of the radio wave including the time information is relatively high in power consumption. Therefore, the fact that the remaining battery level is close to the full-charge (“F”) state is a requirement for performing the wireless communication. Therefore, it is presumable that there is a high possibility that during the period of performing the wireless communication, the indicating hand 41 indicates “F” in the remaining battery level meter 43c. Therefore, in order to quickly change from the situation in which the wireless communication is performed to the state in which the wireless communication is suspended, it is desirable to dispose the icon 43a representing that the wireless communication is suspended adjacent to “F” in the remaining battery level.

In the present embodiment, due to the drive force from the single stepping motor 51, the indicating hand 41 and the indicating hand 42 are driven concentrically. Therefore, the number of the stepping motors can be reduced, the number of components such as the gearwheels for transmitting the drive force from the drive source can also be reduced, it becomes possible to dispose the components such as the drive source and the gear wheels in a small space, and it is possible to achieve reduction in size of the whole of the watch, and enhancement of degree of the design freedom.

In the present embodiment, the second display area 43 is disposed in the range with the central angle of θ1 (108°), the first display area 44 is disposed in the range with the central angle of θ2 (129°) and not overlapping the second display area 43, and the second display area 43 and the first display area 44 are disposed across the concentric axis 40. Therefore, it results that the second display area 43 and the first display area 44 are disposed so as to be opposed to each other and so as not to overlap each other, and thus, the first information and the second information are made easy to distinguish from each other to thereby enhance easiness in reading the first information and the second information.

In the present embodiment, in the area not overlapping the second display area 43 and the first display area 44, and on the straight line passing through the concentric axis 40 and connecting the twelve-o'clock side and the six-o'clock side to each other, there is fixedly disposed the information display section 5b for displaying the day wheel 6 of the calendar. Therefore, it is possible to emphasize the symmetric design, and it is possible to enhance the design stability.

### Modified Example 1

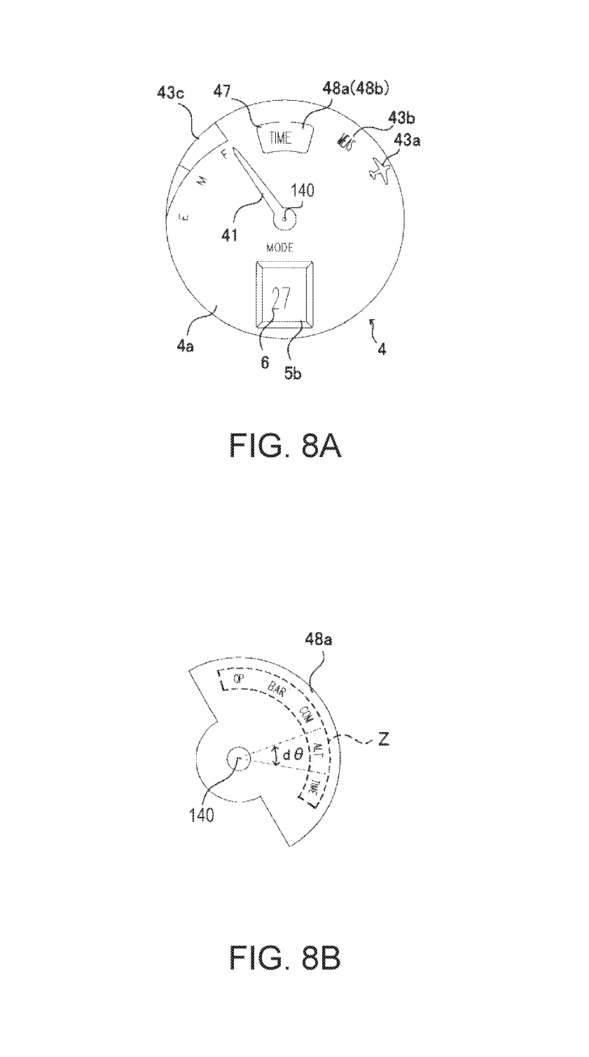

It should be noted that the invention is not limited to the embodiment described above, but a variety of modification can be applied. For example, it is possible to adopt a rotary plate shaped like a circular arc strip rotating around the concentric axis 40 instead of the indicating hand 42 described above. FIG. 8A, FIG. 8B, and FIG. 8C show the six-o'clock information display section related to Modified Example 1, wherein FIG. 8A is a plan view showing a mechanism in the case of displaying the display mode, FIG. 8B is a plan view showing an example of the rotary plate used in Modified Example 1, and FIG. 8C is a plan view showing another example of the rotary plate used in Modified Example 1.

As shown in FIG. 8A, in the six-o'clock information display section 4, an opening section 47 having a rectangular shape, through which a rotary plate 48a located on the lower side can be viewed, is opened in the display section 4a. In the present modified example, in the six-o'clock information display section 4, there are displayed the remaining battery level meter 43c showing the remaining battery level and the mode (the icon 43a representing that the wireless communication is suspended, and the letters 43b of “MEAS” representing that the measurement is in process) as the first information similarly to first embodiment described above, and the opening section 47 is disposed between the remaining battery level meter 43c and the letters 43b of “MEAS.” The indicating hand 41 performs the display in the range from the position of the icon 43a to “E” in the remaining battery level meter 43c, and the indicating hand 41 is controlled to skip the opening section 47 in the case of making the transition from the remaining battery level display to the display mode.

The rotary plate 48a disposed on the lower side of the opening section 47 has a semicircular shape shown in FIG. 8B, and is driven at a second speed around the concentric axis 140 (the concentric axis 40) by the drive force from the stepping motor 51 transmitted by the reduction mechanism B. On the surface of the rotary plate 48a, the second display area Z shaped like a circular arc strip indicated by the dotted lines in the drawing is divided into five display units by the angle dθ around the concentric axis 140 (the concentric axis 40), and is arranged to indicate the “TIME” (time display) mode, the “ALT” (altitude display) mode, the “COMP” (compass) mode, the “BAR” (atmospheric pressure) mode, and the “OP” (option) mode by the letters described in each of the display units thus divided. Here, the mode as the second information is for representing one of the first through K-th elements. In this example, K represents “5,” and “TIME,” “ALT,” “COMP,” “BAR,” and “OP” correspond to the elements.

These display modes can be switched by the holding down operation of the button 14 located on the eight-o'clock side. Specifically, every time the button 14 is held down once, the indicating hand 41 rotates clockwise as much as 360°, and at the same time, the rotary plate 48a rotates clockwise as much as 30° corresponding to the angle dθ to switch from “TIME (time display)” to the “ALT” (altitude display) mode, the “COM” (compass) mode, the “BAR” (atmospheric pressure) mode, and then the “OP” (option) mode in sequence. Then, when the button 14 is held down at the OP mode position, the rotary plate 48a reverses to make the transition to “TIME” corresponding to the most counterclockwise position of the rotary plate 48a. It should be noted that in the example shown in the drawings, the remaining battery level “F” is indicated by the indicating hand 41, and the “TIME” mode (time display) is shown in the opening section 47.

Further, instead of the rotary plate 48a, it is possible to adopt such a rotary plate 48b having a circular shape as shown in FIG. 8C. The rotary plate 48b has a circular shape, and the series of the display modes are described twice repeatedly. Therefore, in the case in which one of the first through K-th elements is shown as the second information, the number of the display units to be formed in the second display area Z becomes 2K. Then, in the second display area Z, the first through K-th elements are arranged in the order along the rotational direction of the rotary plate 48b. Specifically, the elements are arranged in the order of “TIME,” “ALT,” “COM,” “BAR,” and “OP.” Further, “OP” as the K-th element is followed by the series of “TIME,” “ALT,” “COM,” “BAR,” and “OP” as the first through K-th elements. Here, it is assumed that the second information has been changed so as to indicate the first element “TIME” in the state in which “OP” as the K-th element can visually be recognized through the opening section 47. In this case, since the next element to the K-th element “OP” is the first element “TIME,” it becomes possible to make the transition from the K-th element “OP” to the first element “TIME” with a smaller rotational angle than in the case of making the transition of the (K−1)-th element→the (K−2)-th element→ . . . →the first element by reversing the stepping motor 51. As a result, the moving time can be shortened. Further, since it results that the second information is visually recognized through the opening section 47, even if the series of the first through K-th elements are arranged twice on the rotary plate 48a, there is no chance of confusing the user.

Further, instead of the rotary plates 48a, 48b exposed from the opening section 47 having a rectangular shape in the six-o'clock information display section 4, it is possible to use a digital display section using, for example, a liquid crystal display and disposed so as to correspond to the opening section 47. In this case, it is possible to adopt a display using both of the indicating hand 41 for indicating the remaining battery level meter 43c representing the remaining battery level and the mode (the icon 43a representing that the wireless communication is suspended, and the letters 43b of “MEAS” representing that the measurement is in progress) as the first information, and the digital display corresponding to the rotary plates 48a, 48b displayed in the digital display section.

According to the electronic watch W with sensors related to the first embodiment and the Modified Example 1 described above, since the current time, the location information and the locomotion information (the information of the physical quantities) of the user, and so on are displayed using the indicating hands 1, 2, 33, 34, 41, 42, 71, and 72 in the state of being worn by the user, the visibility of the display is improved, and it becomes possible to display the information in the display section 5 relatively small in size. Thus, even if the electronic watch W with sensors as the wrist apparatus is mounted, mounting superficially similar to the ordinary wristwatch can be realized, and it becomes possible to improve the wearability, and at the same time improve the fashionability as the electronic watch W with sensors.

Further, the power supply section 106 is provided with the power generation section 120 provided with the self-power generation function formed of a photovoltaic generation system for converting optical energy such as the solar light into electrical energy using a solar cell, or a so-called self-winding generation system for converting the kinetic energy of the rotary weight rotating due to the movement of the arm of the user into the electrical energy, or the like. Further, the electronic watch W with sensors is provided with the power generation section 120 having the self-power generation function, and can therefore generate enough power for the power consumption, and can be equipped with the function such as the GPS relatively high in power consumption, the plurality of sensors, and so on. Further, in the power supply section 106, the power is generated using the solar light as natural energy easy for the user to obtain, or using the motion of the arm of the user (wearer), and therefore, it is possible to use so-called clean energy having no influence on the environment as the power source (power supply).

According to the configurations described above, it is possible to provide the electronic watch W with sensors as the wrist apparatus capable of obtaining the information including the information the user wants in everyday life such as the location information due to, for example, the GPS (global positioning system).

Further, the electronic watch W with sensors includes either of the acceleration sensor 101, the pressure sensor 102, and the orientation sensor 103 for detecting the physical quantities as the information, and can therefore easily obtain the information such as the moving amount (the amount of exercise) including the moving direction and the difference in altitude of the user (wearer) as the information the user wants in addition to the location information due to, for example, the GPS (global positioning system).

### Modified Example 2

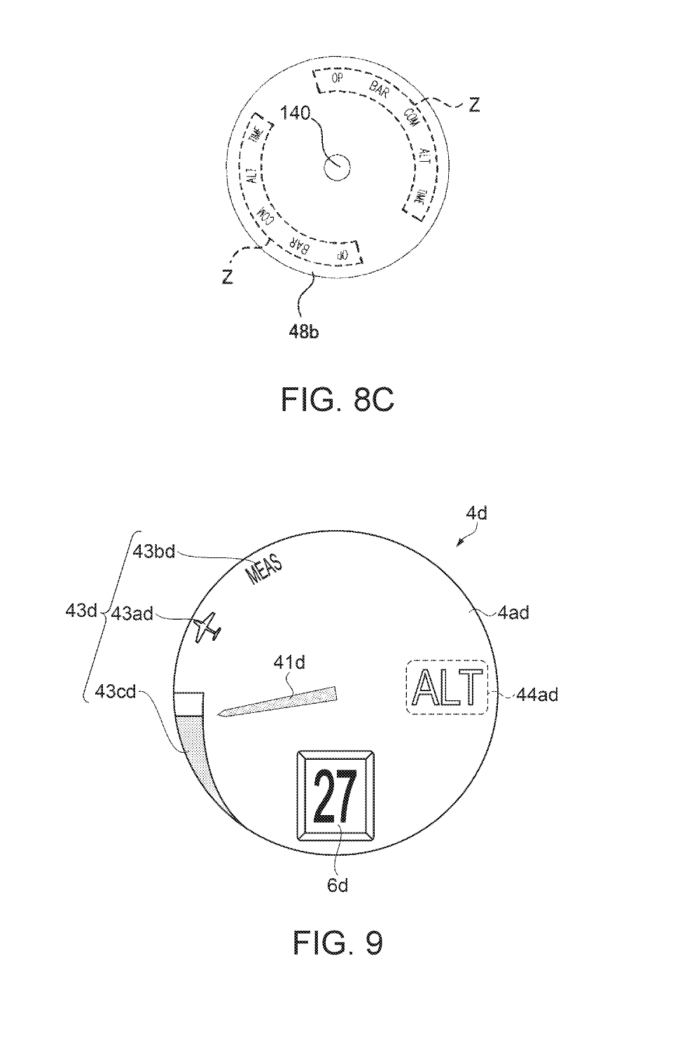

It should be noted that a six-o'clock information display section 4d formed of a digital display section 4ad corresponding to the six-o'clock information display section 4 as the circular small window section as in Modified Example 2 shown in FIG. 9 can also be adopted as the six-o'clock information display section 4. FIG. 9 is a plan view showing the six-o'clock information display section related to Modified Example 2. It should be noted that in Modified Example 2, the information displayed by the six-o'clock information display section 4d is displayed digitally, and regarding other display, the analog display indicated by the indicating hand (the hour hand) 1, the indicating hand (the minute hand) 2, the indicating hand (the second hand) 34 of the ten-o'clock information display section 3, the measurement indicating hands 71, 72 of the two-o'clock information display section 7, and so on is performed. In other words, in the display method according to Modified Example 2, the location information, the physical information, the biological information, and so on are displayed using both of the analog display and the digital display.

As shown in FIG. 9, in the six-o'clock information display section 4d related to Modified Example 2, the remaining battery level meter 43cd representing the remaining battery level, the indicating hand 41d for indicating the mode (the icon 43ad representing that the wireless communication is suspended, the letters 43bd of “MEAS” representing that the measurement is in process), the “ALT” display 44ad as the display mode representing the altitude, and a calendar display section 6d for displaying the calendar are displayed digitally. In other words, the six-o'clock information display section 4d related to Modified Example 2 is formed of, for example, a displaying display (a liquid crystal panel) using a liquid crystal display (LCD: liquid crystal display). It should be noted that as the displaying display, it is possible to use an electrophoretic display (EPD) module, an organic electro-luminescence display (OLED) module, and so on. Further, as the display modes, there are selected and displayed “TIME” (the time), “COM” (a compass; the orientation), “BAR” (the atmospheric pressure), “OP” (the option) and so on besides “ALT” as the display mode for showing the altitude.

As described above, in the display section 5, by using both of the analog display indicated by the indicating hand (the hour hand) 1, the indicating hand (the minute hand) 2, the indicating hand (the second hand) 34, the measurement indicating hands 71, 72, and so on, and the digital display indicated by the six-o'clock information display section 4d, the types of the information and the amount of the information which can be presented can be increased.

It should be noted that in Modified Example 2, the configuration of performing the digital display using the six-o'clock information display section 4d is described. However, the configuration is not limited to this example, but the digital display can also be used in the ten-o'clock information display section 3 and the two-o'clock information display section 7.

### Modified Example 3

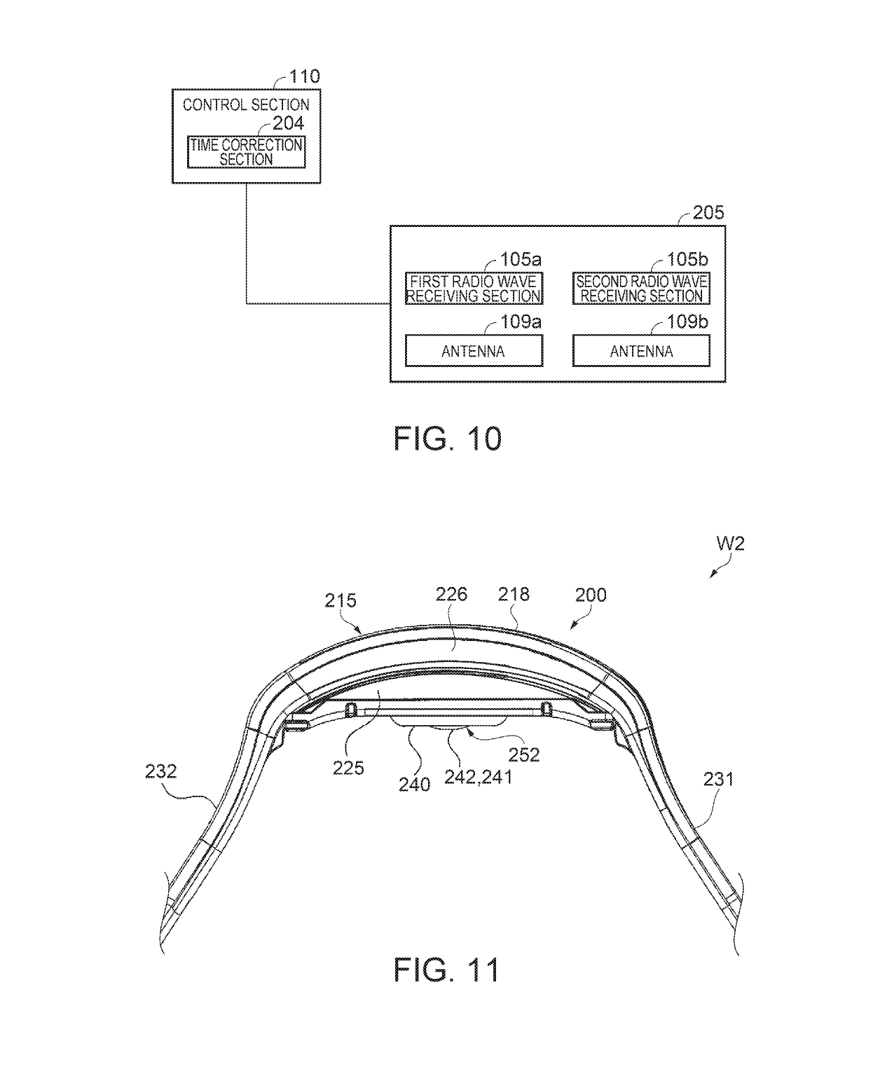

Then, Modified Example 3 of the electronic watch W with sensors will be described with reference to FIG. 10. FIG. 10 is a functional block diagram showing a configuration of a receiving section related to Modified Example 3. As shown in FIG. 10, in the electronic watch W with sensors according to Modified Example 3, the receiving section 205 can be provided with a first radio wave receiving section 105a and a second radio wave receiving section 105b for respectively receiving two radio waves different from each other as the time information. Specifically, the receiving section 205 includes the first radio wave receiving section 105a connected to an antenna 109a and the second radio wave receiving section 105b connected to an antenna 109b. It should be noted that the configuration of the first radio wave receiving section 105a and the antenna 109a corresponds to the receiving section 105 shown in the first embodiment. Further, the configuration of the second radio wave receiving section 105b and the antenna 109b corresponds to a second receiving section.

The first radio wave receiving section 105a receives a high-frequency radio wave (the satellite signal) including the GPS time information and the orbital information from the GPS satellites 8 (see FIG. 1A) using the antenna 109a. The radio wave (the satellite signal) from the GPS satellite 8 is a high-frequency radio wave (L1 wave) at, for example, 1.57542 GHz. The patch antenna for receiving the high-frequency radio wave for the GPS can be used as the antenna 109a.

The second radio wave receiving section 105b receives the standard wave transmitted from a base station (transmitting station) using the antenna 109b. The standard wave includes the time information for automatically correcting the time, and is the radio wave at 40 KHz transmitted from the Fukushima station (eastern Japan district) and the radio wave at 60 KHz transmitted from the Kyushu station (western Japan district) in Japan. The bar antenna for receiving the long wave (e.g., 40 through 77.5 KHz) for the standard time can be used as the antenna 109b.

The receiving section 205 (the first radio wave receiving section 105a and the second radio wave receiving section 105b) is connected to the control section 110 (a time correction section 204). The control section 110 is provided with the time correction section 204 for obtaining the time information included in the satellite signal using the first radio wave receiving section 105a or the second radio wave receiving section 105b, and then performing the correction (correction of the current time) of the time based on the reception result. Then, the time information corrected by the time correction section 204 is displayed on the time display section (not shown) for displaying the time.

The time correction section 204 can perform the correction (time adjustment) of the time based on the time information of the radio wave (the satellite signal) from the GPS satellites 8 in the case in which, for example, the first radio wave receiving section 105a receives the radio wave (the satellite signal) from the GPS satellites 8. Then, in the case in which the radio wave (the satellite signal) from the GPS satellites 8 cannot be received, the time correction section 204 switches the time information source to be the reference of the correction (the time adjustment) of the time, and can perform the correction (the time adjustment) of the time based on the standard wave transmitted from the base station (the transmitting station) having been received by the second radio wave receiving section 105b.

According to the configuration of Modified Example 3, since the radio waves with the respective frequencies different from each other each including the time information can be received, in the case in which, for example, the user is located at the place where the radio wave cannot be received, even if either one of the radio waves (the satellite signals) cannot be received, it becomes possible to perform the correction (the time adjustment) of the time applying the other radio wave (the standard wave). Thus, the electronic watch W with sensors can always display the correct measurement of the time continuously. It should be noted that it is preferable to adopt a configuration of operating the second radio wave receiving section 105b small in power consumption compared to the first radio wave receiving section 105a to correct the time in the case of using the electronic watch W with sensors in the district where the standard wave can be received. Further, it is preferable to adopt a configuration of not operating the second radio wave receiving section 105b in the case of using the electronic watch W with sensors in the district where the standard wave cannot be received. By adopting these configurations, the wasteful power consumption due to the time adjustment can be prevented from occurring, and therefore, the risk of the system halt due to the lowering of the electric power of the secondary battery can be reduced.

Further, although not shown in the drawings, it is possible for the electronic watch W with sensors to include either of an illuminance sensor, a temperature sensor, and a humidity sensor as a sensor for detecting physical quantities as the information. By using such sensors, it is possible to easily obtain the information related to the prediction of the weather such as how the weather is going to change from now in addition to the information described above.

### Second Embodiment

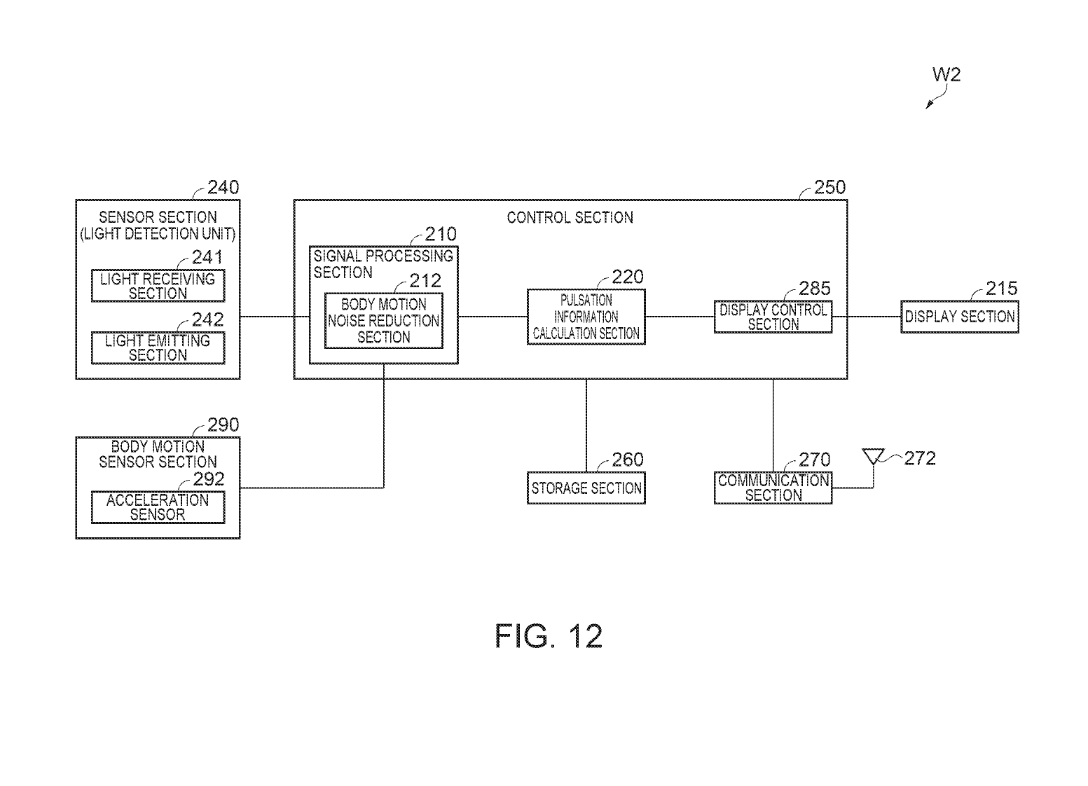

The electronic watch with sensors according to the second embodiment of the wrist apparatus according to the invention will be described with reference to FIG. 11 and FIG. 12. FIG. 11 is a perspective view showing a schematic configuration of the electronic watch with sensors according to the second embodiment. FIG. 12 is a functional block diagram showing a configuration of the electronic watch with sensors according to the second embodiment.

The electronic watch W2 with sensors according to the second embodiment as the wrist apparatus shown in FIG. 11 and FIG. 12 is provided with a function of detecting biological information by a biological information detection sensor as other sensors in addition to the function of the wristwatch, the positioning calculation (acquisition of the location information) function, and the function of detecting the information of the physical quantities by the plurality of sensors described in the first embodiment. Further, the electronic watch W2 with sensors displays the information of the time, the location information, the information of the physical quantities, and so on with indicating hands (not shown in FIG. 11) similar to those in the first embodiment in a display section 215 located on an opposite surface to the surface having contact with an arm of the user (wearer). It should be noted that in the following description, explanations for the same configurations and the same functions as those in the first embodiment described above will be omitted.

As shown in FIG. 11, the electronic watch W2 with sensors is mounted on a given region (e.g., the wrist) of the user (the wearer), and displays the current time, and the location information and the locomotion information (information of the physical quantities) of the user, the biological information, and so on. The electronic watch W2 with sensors includes an apparatus main body 200 mounted on the user to detect and display the current time, and the location information, the locomotion information (the information of the physical quantities) of the user, the biological information, and so on, and band parts 231, 232 attached to the apparatus main body 200 to mount the apparatus main body 200 on the user. Further, the electronic watch W2 with sensors is provided with a power generation section provided with the self-power generation function not shown in the drawing and a power supply section including a secondary cell (a rechargeable battery) capable of charging the electrical energy generated by the power generation section. Further, the electronic watch W2 with sensors includes a receiving section and an antenna not shown in the drawings, and has a function of receiving the satellite signals.

The apparatus main body 200 is provided with a bottom case (a back lid part) 225 disposed on the side on which the apparatus is mounted on the user, and is provided with a top case 226 disposed on the opposite side to the side on which the apparatus is mounted on the user. The bottom case 225 and the top case 226 each can be formed of metal such as stainless steel, or resin, but are each preferably formed of metal. By forming the bottom case 225 and the top case 226 as the case using metal, it is possible to shield external disturbance noise, which affects the detection result of the plurality of sensors housed in the bottom case 225 and the top case 226. Further, it is possible to evoke a high-class taste and improve fashionability.

On the top side (the top case 226) of the apparatus main body 200, there is disposed a glass plate 218 as a top plate part (an outer wall) for protecting the internal structure. It is also possible for the apparatus main body 200 to have a configuration in which there is provided a display section 215 disposed immediately below the glass plate 218 via the glass plate 218, and the user can view the display of the display section 215. In other words, in the electronic watch W2 with sensors according to the present embodiment, there can be adopted a configuration in which a variety of types of information such as the location information, the locomotion information (the information of the physical quantities), the biological information, and the time information thus detected are displayed on the display section 215, and the display is provided to the user from the top side of the apparatus main body 200.

It should be noted that although the example of realizing the top plate part of the apparatus main body 200 by the glass plate 218 is described here, it is possible to form the top plate part with a material other than glass such as transparent plastic proving the member made of the material is a transparent member through which the display section 215 can be viewed, and has strength sufficient for protecting the constituents such as the display section 215 included inside the top case 226 and the bottom case 225. It should be noted that a solar cell (not shown) having a power generation function due to the solar light or the like can be disposed on the surface of the display section 215.

On the bottom side (the bottom case 225 as the back lid part) of the apparatus main body 200, there is disposed a sensor section (a pulse wave measurement sensor) 240 as an example of the biological information detection sensor for detecting the biological information. The sensor section (the pulse wave measurement sensor) 240 is for detecting the biological information such as a pulse wave of the user (a test subject). For example, the sensor section 240 has a receiving section 241 and a light emitting section 242 (see FIG. 12). The sensor section 240 has a light emitting window section 252, and the light emitting window section 252 and the sensor section 240 of the light emitting window section 252 project from the bottom case 225 toward the side on which the apparatus is mounted on the user. The light emitting window section 252 is formed of a light transmissive member, and has contact with the surface of the skin of the user (the test subject) to apply pressure. As described above, in the state in which the light emitting window section 252 applies the pressure to the surface of the skin, the light emitting section 242 emits light, then the light receiving section 241 receives the light having been emitted by the light emitting section 242 and then reflected by the test subject (a blood vessel), and then the light reception result is output as a detection signal to the signal processing section 210 (see FIG. 12).

As shown in the block diagram of FIG. 12, the electronic watch W2 with sensors according to the second embodiment of the wrist apparatus includes the sensor section (the pulse wave measurement sensor) 240 as the biological information detection sensor, a body motion sensor section 290 as a sensor for detecting the information of the physical quantities, a control section 250, a storage section 260, a communication section 270, and antenna 272, and the display section 215. It should be noted that the biological information measurement apparatus according to the present embodiment is not limited to the configuration shown in FIG. 12, and can be implemented with a variety of modifications such as elimination of some of the constituents, replacement with other constituents, or addition of other constituents.

The sensor section (the pulse wave measurement sensor) 240 is for detecting the biological information such as a pulse wave, and includes the light receiving section 241 and the light emitting section 242. Due to the light receiving section 241, the light emitting section 242, and so on, the pulse wave sensor (a photoelectric sensor) is realized. The sensor section 240 outputs the signal, which has been detected by the pulse wave measurement sensor, as a pulse wave detection signal. It should be noted that the sensor section 240 as the biological information detection sensor is not limited to the pulse wave measurement sensor, but can be provided with a configuration including either one of a pulse rate measurement sensor, a blood pressure measurement sensor, a body temperature sensor, and a galvanic skin response sensor.

The body motion sensor section 290 as the sensor for detecting the physical quantity outputs a body motion detection signal as a signal varying in accordance with the body motion based on the sensor information of a variety of sensors. The body motion sensor section 290 includes, for example, an acceleration sensor 292 as the body motion sensor. It should be noted that the body motion sensor section 290 can also be provided with a pressure sensor, a gyro sensor, and so on as the body motion sensor.

The control section 250 is for performing a variety of types of signal processing and control processing using, for example, the storage section 260 as a working area, and can be realized by a processor such as a CPU or a logic circuit such as an ASIC. The control section 250 includes a signal processing section 210, a pulsation information calculation section 220, and a display control section 285.

The control section 250 detects the biological information such as the pulse wave based on the detection signal from the sensor section 240. It should be noted that the biological information to be the detection target of the electronic watch W2 with sensors according to the present embodiment is not limited to the pulse wave (the pulse rate). It is possible to adopt a device for detecting the biological information other than the pulse wave (e.g., oxygen saturation in blood vessels, the body temperature, and the heart rate).

Further, the biological information to be the detection target of the electronic watch W2 with sensors according to the present embodiment is not limited to the pulse wave (the pulse rate), but preferably includes an index representing at least one of the biological information such as SpO₂ (percutaneous arterial blood oxygen saturation), VO₂ₘₐₓ (maximum oxygen uptake), the body temperature, the lactate level, SvO₂ (oxygen saturation of hemoglobin), a sleeping condition, stress, a blood sugar level, arrhythmia, calorie consumption, metabolism, and ovulation.

Further, the biological information to be the detection target of the electronic watch W2 with sensors can be defined as the information related to the physiological condition of an individual based on the data representing at least one of the physiological parameters such as the heart rate, the pulse rate, a variation between pulsations, EKG (elektrokardiogram), ECG (electrocardiogram), the breathing rate, the cutaneous temperature, the body temperature, body heat flow, the galvanic skin response, GSR (galvanic skin reflex), EMG (electromyogram), EEG (electroencephalogram), EOG (electrooculography), the blood pressure, body fat, the hydration level, the activity level, the body motion, the oxygen consumption, glucose, the blood sugar level, the muscle mass, the pressure applied to the muscle, the pressure applied to the bones, ultraviolet absorption, the sleeping condition, the physical condition, the stress state, and the body posture (e.g., decumbence, erection, and seated posture).

If such an index is detected, the body condition and the mental condition of the user (the wearer) can easily be figured out.

The signal processing section 210 is for performing a variety of types of signal processing (e.g., a filter process), and performs the signal processing on, for example, the pulse wave detection signal from the sensor section 240 and the body motion detection signal from the body motion sensor section 290. For example, the signal processing section 210 includes a body motion noise reduction section 212. The body motion noise reduction section 212 performs a process of reducing (eliminating) the body motion noise, which is the noise caused by the body motion, from the pulse wave detection signal based on the body motion detection signal from the body motion sensor section 290. Specifically, the noise reduction process using, for example, an adaptive filter is performed.

The pulsation information calculation section 220 performs the calculation process of the pulsation information based on the signal or the like from the signal processing section 210. The pulsation information is the information such as the pulse rate. Specifically, the pulsation information calculation section 220 performs a frequency analysis process such as FFT on the pulse wave detection signal, on which the noise reduction process by the body motion noise reduction section 212 has been performed, to obtain the spectrum, and then performs a process of determining the representative frequency in the spectrum thus obtained as the frequency of the heartbeat. The value obtained by multiplying the frequency thus obtained by 60 is the pulse rate (the heart rate) used commonly. It should be noted that the pulsation information is not limited to the pulse rate itself, but can also be, for example, other variety of types of information (e.g., the frequency or the period of the heartbeat) representing the pulse rate. Further, the pulsation information can also be the information representing the state of the pulsation, or it is also possible to use, for example, the value representing the blood volume itself as the pulsation information.

The display control section 285 controls the display section 215. The display section 215 displays a variety of types of information to the user due to the control by the display control section 285. The specific display method of the display section 215 is substantially the same as in the first embodiment described above, and therefore, the explanation thereof will be omitted.

The communication section 270 performs the communication process with the other sensor apparatus C (see FIG. 17). The communication section 270 performs the process of the wireless communication compliant with a standard such as Bluetooth (registered trademark). Specifically, the communication section 270 performs a reception process of a signal from the antenna 272, and a transmission process of a signal to the antenna 272. The function of the communication section 270 can be realized by a processor for communication or a logic circuit such as an ASIC.

According to the electronic watch W2 with sensors related to the second embodiment of the wrist apparatus, it is possible to easily obtain the biological information such as the pulse rate, the blood pressure value, or the blood sugar level of the user (the wearer) in addition to the location information and the information of the physical quantities. Thus, it is possible for the user to obtain the health information and the body information as a life log.

Further, according to the electronic watch W2 with sensors, since the sensor section (the pulse wave measurement sensor) 240 as an example of the biological information detection sensor is disposed in the bottom case 225 as a back lid part, it is possible to make the sensor section (the pulse wave measurement sensor) 240 adhere to the mounting region (the arm part) of the user (the wearer), and thus, the biological information can more accurately be detected.

### Modified Example

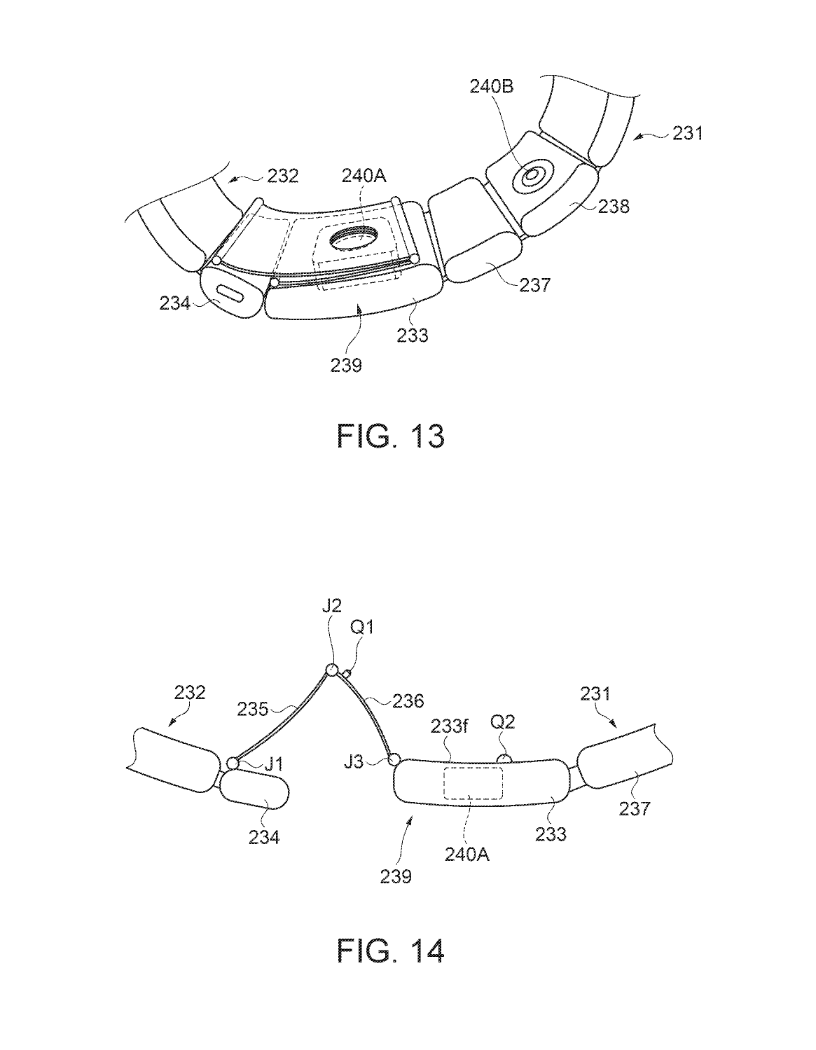

It should be noted that the sensor section 240 as the biological information detection sensor according to the second embodiment described above can be disposed on, for example, a band part or a buckle part. Hereinafter, a modified example of the electronic watch W2 with sensors according to the second embodiment will be explained with reference to FIG. 13 and FIG. 14. FIG. 13 is a perspective view showing a schematic configuration of the modified example of the electronic watch with sensors according to the second embodiment. FIG. 14 is a front view schematically showing a configuration example of the buckle part.

As shown in FIG. 13 and FIG. 14, sensor sections 240A, 240B related to the modified example can be disposed in a buckle part 239 and a band piece part 238 of a band part 231, respectively.

Specifically, the sensor section 240B is housed in the band piece part 238. The band parts 231, 232 are disposed on the both sides of the case section not shown. Each of the band parts 231, 232 is formed of the band piece parts such as the band piece part 237 and the band piece part 238 connected to each other. Further, the sensor section 240B is housed in the band piece part 238 constituting one band part 231 so that a part of the sensor section 240B is exposed toward the side on which the band part 231 is mounted on the user. It should be noted that the band piece part 238 can be configured so as to detachably be attached as an adjustment piece for adjusting the length of the band part 231.

Since the sensor section 240B as the biological information detection sensor is disposed in the band piece part 238 constituting the band part 231 as described above, the sensor section 240B can easily be replaced (detached and attached) by detaching and attaching the band piece part 238, or by detaching and attaching the band parts 231, 232. Thus, it is possible to easily customize the apparatus such that the type of the sensor is changed in accordance with the demand of the user.

Further, specifically, the sensor section 240A can be provided with a configuration of being housed in the buckle part 239. The buckle part 239 is provided with a first plate 235, a second plate 236, a connection piece part 234 for the first plate 235, and a connection piece part 233 for the second plate 236.

In the buckle part 239, one end of the first plate 235 and one end of the second plate 236 are supported with a shaft so as to be able to rotate with each other in a hinge section J2. The other end of the first plate 235 is supported with a shaft so as to be able to rotate with respect to the connection piece part 234 in a hinge section J1. The other end of the second plate 236 is supported with a shaft so as to be able to rotate with respect to the connection piece part 233 in a hinge section J3. Further, the second plate 236 has a click part Q1 disposed on the one end side.

In the buckle part 239, by moving the click part Q1 of the second plate 236 toward a guide part Q2 provided to a surface 233f of the connection piece part 233 on the side on which the band is mounted on the user (the wearer) so as to fold the buckle part 239 using the respective hinge sections J1, J2, and J3 as the rotary shafts, and then engaging the click part Q1 and the guide part Q2 with each other, there is obtained the wearable state in which the buckle part 239 is folded. Further, it is possible to adopt a configuration in which the sensor section 240A is housed in the connection piece part 233 of the buckle part 239 described above.

Since the sensor section 240A as the biological information detection sensor is disposed in the connection piece part 233 constituting the band part 231 as described above, the sensor section 240A can easily be replaced by detaching and attaching the band parts 231, 232. Thus, it is possible to easily customize the apparatus such that the type of the sensor is changed in accordance with the demand of the user.

### Third Embodiment

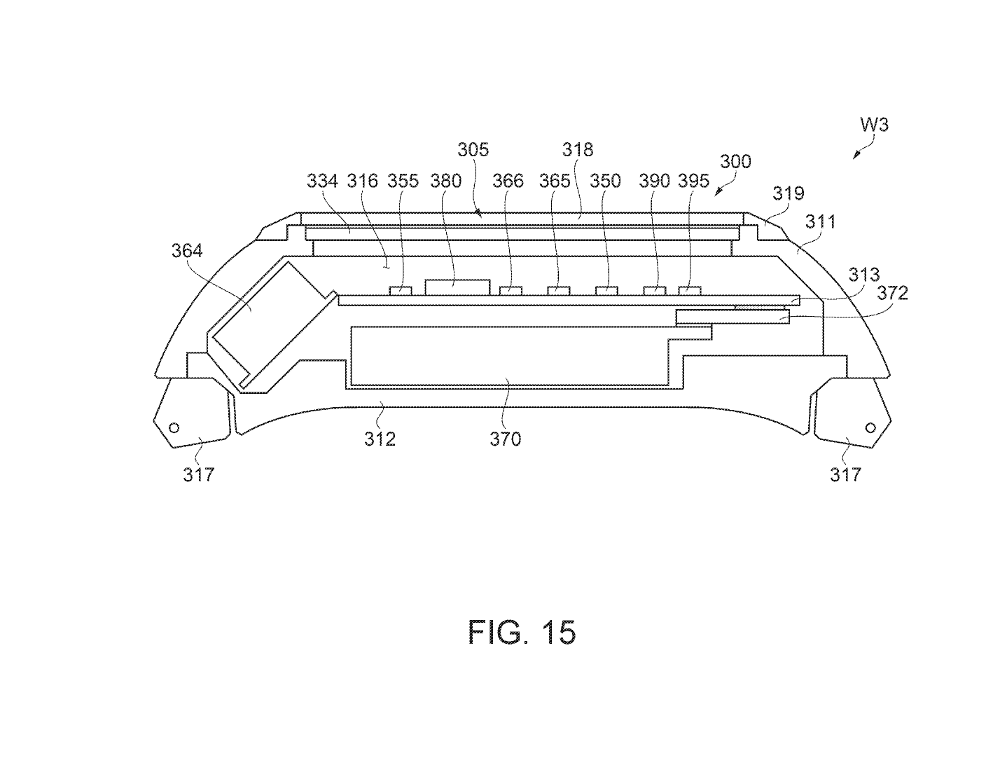

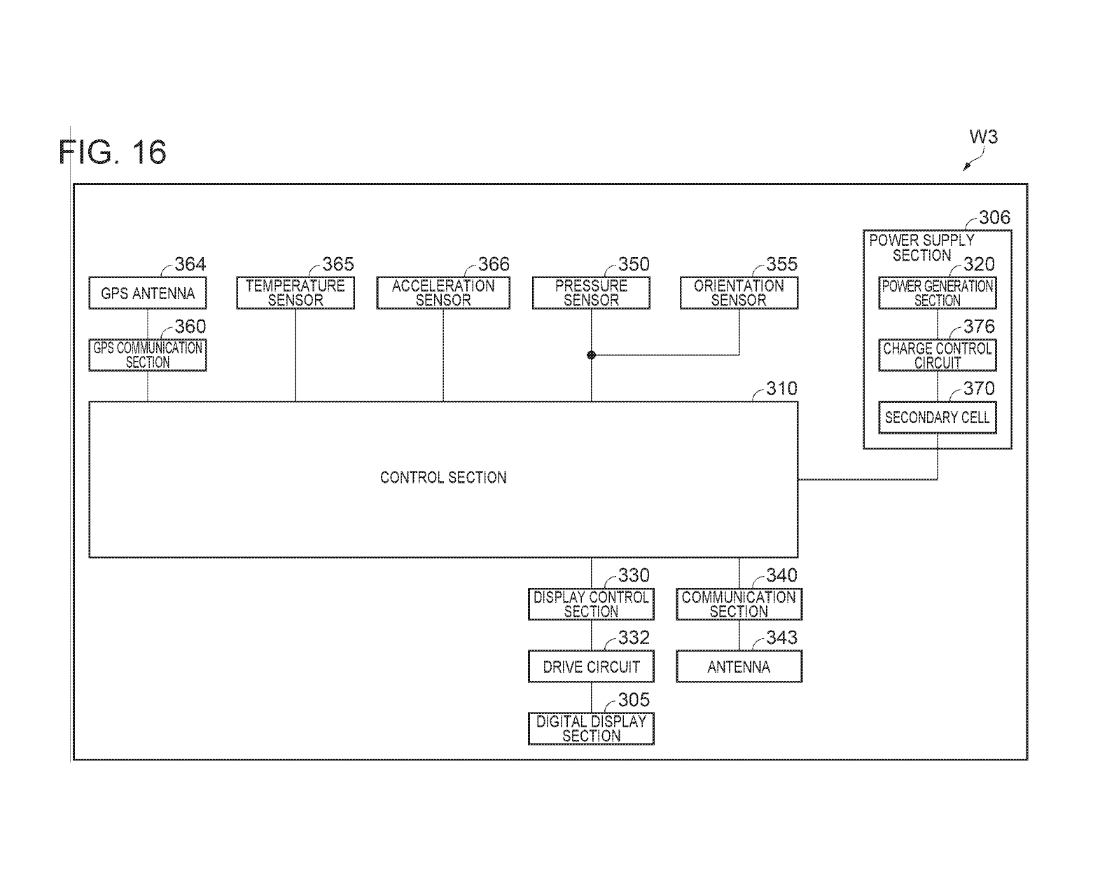

The electronic watch with sensors according to the third embodiment of the wrist apparatus according to the invention will be described with reference to FIG. 15 and FIG. 16. FIG. 15 is a perspective view showing a schematic configuration of the electronic watch with sensors according to the third embodiment. FIG. 16 is a functional block diagram showing a configuration of the electronic watch with sensors according to the third embodiment.

The electronic watch W3 with sensors according to the third embodiment as the wrist apparatus shown in FIG. 15 and FIG. 16 is provided with the function of the wristwatch, the positioning calculation (acquisition of the location information) function, the function of detecting the information of the physical quantities by the plurality of sensors described in the first embodiment. Further, the electronic watch W3 with sensors according to the third embodiment is provided with a liquid crystal display (LCD 334) as a digital display section 305 which is located on the surface on the opposite side to the surface on the side having contact with the arm of the user (the wearer), and is displayed with the digital display. It should be noted that in the liquid crystal display (LCD 334), the time information, the location information, the information of the physical quantities, and so on are displayed using indicating hand (not shown in FIG. 15 and FIG. 16) formed using the digital display. Further, the display configuration and the function of the liquid crystal display (LCD 334) are substantially the same as in the first embodiment described above. Therefore, in the following description, explanations for the same configurations and the same functions as those in the first embodiment described above will be omitted.

As shown in FIG. 15, an apparatus main body 300 is provided with a bottom case (a back lid) 312 disposed on the side on which the apparatus is mounted on the user, and is provided with a top case 311 disposed on the opposite side to the side on which the apparatus is mounted on the user. The bottom case 312 and the top case 311 each can be formed of metal such as stainless steel, or resin, but are each preferably formed of metal similarly to the first embodiment.

On the top side (in the top case 311) of the apparatus main body 300, there is disposed a bezel 319, and at the same time, there is disposed a glass plate 318 as a top plate part (an outer wall) disposed inside the bezel 319 to protect the internal structure. The apparatus main body 300 has a configuration in which it is possible for the user to view the display of the display section such as the liquid crystal display (hereinafter described as LCD 334) as the digital display section disposed immediately below the glass plate 318 via the glass plate 318. In other words, in the electronic watch W3 with sensors according to the present embodiment, a variety of types of information such as the location information, the exercise information, and the time information thus detected are displayed by the LCD 334 as the digital display section, and the display is provided to the user from the top side of the apparatus main body 300. Further, on the both sides of the bottom case 312, there are disposed a pair of band mounting sections 317 as the connection sections with the band parts (not shown).

It should be noted that although the example of realizing the top plate part of the apparatus main body 300 by the glass plate 318 is described here, it is possible to form the top plate part with a material other than glass such as transparent plastic proving the member made of the material is a transparent member through which the LCD 334 can be viewed, and has strength sufficient for protecting the constituents such as the LCD 334 included inside (in the internal space 316) the top case 311 and the bottom case 312. Further, although there is described the configuration example provided with the bezel 319, it is also possible to adopt a configuration not provided with the bezel 319.

The apparatus main body 300 is provided with the internal space 316 surrounded by the top case 311, the bottom case 312, and the glass plate 318. Further, the apparatus main body 300 has a circuit board 313, a GPS (global positioning system) antenna 364 connected to the circuit board 313, a plurality of sensors (a pressure sensor 350, an orientation sensor 355, a temperature sensor 365, and an acceleration sensor 366), a battery board 372 to which terminals of a secondary cell 370 are connected, electronic components such as a first circuit component 380, a second circuit component 395, a DC-DC converter 390 constituting a control section 310 (see FIG. 16), and the LCD 334 (the liquid crystal display) and so on disposed in the internal space 316. Further, in the internal space 316 of the apparatus main body 300, there is provided a power supply section 306 (see FIG. 16) including a power generation section 320 having a self-power generation function not shown. It should be noted that the configuration of the electronic watch W3 with sensors (the apparatus main body 300) is not limited to the configuration shown in FIG. 15, but it is possible to add other constituents, or eliminate some of the constituents. For example, it is also possible to add a communication section 340 (see FIG. 16) including an antenna 343 for communication for performing the communication with other information processing apparatuses (not shown), a biological information measurement sensor, and so on, or it is possible to eliminate the GPS antenna 364.

It is possible for the LCD 334 (the liquid crystal display) constituting the digital display section 305 to display, for example, the location information using the GPS and the plurality of sensors, the exercise information (the information of the physical quantities) such as the moving amount and the exercise amount, the biological information such as the pulse rate, or the time information such as the current time in accordance with the respective modes. In the LCD 334, at least the indicating hand (not shown) formed using the digital display is formed, and by the digital indicating hand (not shown), a variety of types of information having substantially the same configuration as the first embodiment described above are displayed. Further, the display can be viewed (visually recognized) by the user via the glass plate 318.

It should be noted that although in the above description, the explanation is presented illustrating the liquid crystal display (LCD 334) using the liquid crystal display (LCD) as the digital display section 305, the configuration of the display is not limited to this example. As the configuration of the display, it is preferable to use at least one of, for example, an electrophoretic display module (EPD), an organic electro-luminescence display (OLED), and the liquid crystal display (LCD).

By using such a configuration of the display, it is possible to easily perform the digital display. It should be noted that if the electrophoretic display module (EPD) is used, the power consumption is suppressed, and at the same time, good visibility can be obtained in a bright place. Further, if the organic electro-luminescence display (OLED) is used, an excellent color developing property can be obtained, and the luminance can be improved. Further, if the liquid crystal display (LCD) is used, the price is moderate, and the influence on the temperature variation can be reduced. Further, by using a memory liquid crystal display among the liquid crystal displays (LCD), good visibility in a bright place can be obtained.

Then, a configuration of the electronic watch W3 with sensors will be described with reference to FIG. 16. As shown in FIG. 16, the electronic watch W3 with sensors includes the control section 310, the plurality of sensors (the temperature sensor 365, the acceleration sensor 366, the pressure sensor 350, and the orientation sensor 355), the communication section 340 including the antenna 343, a GPS communication section 360 including the GPS antenna 364, the digital display section 305 for displaying the information, and the power supply section 306 for driving the electric circuit system.

The temperature sensor 365 is capable of measuring the ambient temperature and so on of the place (current location) where the user exists. The acceleration sensor 366 is capable of measuring the moving direction and the moving amount of the user. The pressure sensor (the atmospheric pressure sensor) 350 is capable of obtaining the information related to the height above the sea level (the altitude) of the place (present location) where the user is located based on the atmospheric pressure value measured. The orientation sensor (a geomagnetic sensor) 355 is capable of measuring the bearing (orientation) the user faces to such as the orientation of north. Further, based on the association between the direction (the moving direction) of the acceleration measured by the acceleration sensor 366 and the direction (the orientation) of the geomagnetism measured by the orientation sensor (the geomagnetic sensor) 355, it is possible to, for example, get hold of the minute actual moving performance, and obtain the information related to an amount of exercise. Here, the temperature, the acceleration and the atmospheric pressure (the altitude) are each an example of the physical quantity (physical information) expressed by a numerical value.

The communication section 340 is capable of communicating with the other sensor apparatus C (see FIG. 17) via the antenna 343, and is capable of performing the exchange of the information measured by the other sensor apparatus C.

The GPS communication section 360 includes the GPS antenna 364, and has a function of receiving the satellite signals. It should be noted that it is preferable for the GPS antenna 364 to be at least one of a ring antenna and a patch antenna. By adopting such a GPS antenna 364, the GPS antenna 364 can easily be fitted into the capacity of (housed by) a small apparatus. For example, if the ring antenna is used, the reception sensitivity can be enhanced, and if the patch antenna is used, it is possible to increase the degree of design freedom of the apparatus such as the arrangement layout of the sensors.

The digital display section 305 includes a display control section 330 for controlling the display content, and a drive circuit 332 for driving the LCD 334 (see FIG. 15) constituting the digital display section 305 due to the support by the display control section 330. In the digital display section 305, the indicating hand (the hour hand) 1, the indicating hand (the minute hand) 2, the measurement indicating hand (the indicating hand) 33, the indicating hand (the second hand) 34, the indicating hand (the first indicating hand) 42, the indicating hand (the second indicating hand) 41, the ten-o'clock information display section 3, the six-o'clock information display section 4, and so on similar to those of the first embodiment described with reference to FIG. 3 are displayed using the digital display.

The control section 310 controls the electronic watch W3 with sensors. The control section 310 is formed of a processor such as a CPU. The control section 310 measures the time (the internal time) with, for example, an internal timepiece not shown, and then corrects the internal time using the satellite signals received by the GPS communication section 360.

The control section 310, the plurality of sensors (the temperature sensor 365, the acceleration sensor 366, the pressure sensor 350, and the orientation sensor 355), the communication section 340 including the antenna 343, a GPS communication section 360 including the GPS antenna 364, the digital display section 305 for displaying the information, and the power supply section 306 for driving the electric circuit system are driven using the power supply section 306 including the power generation section 320 and the secondary cell (the rechargeable battery) 370 as the power source.

The power supply section 306 has the power generation section 320 provided with a self-power generation function, and the secondary cell (the rechargeable battery) 370 which can be charged with the electrical energy generated by the power generation section 320. The power generation section 320 can be formed of a photovoltaic generation system for converting optical energy such as the solar light into electrical energy using a solar cell, or a so-called self-winding generation system for converting the kinetic energy of a rotary weight rotating due to the movement of the arm of the user into the electrical energy. It should be noted that in the present embodiment, it is sufficient to be provided with at least either one of the photovoltaic generation system and the self-winding generation system.

The solar cell (not shown) constituting the photovoltaic generation system shown as an example of the power generation section 320 can be disposed on the frame part of the LCD 334 (see FIG. 15) of the digital display section 305, and the surface of the bezel 319 (see FIG. 15). The solar cell can receive the light such as the solar light or the light of a fluorescent light to generate the power, the electrical energy thus generated is stored in the secondary cell (the rechargeable battery) 370, and is used as the energy for driving the watch and the energy for driving a variety of sensors. Further, in the self-winding generation system (not shown) described as an example of the power generation section 320, a permanent magnet is rotated in the vicinity of a coil using the movement of a rotary weight having a semicircular shape and rotating due to the motion of the arm of the user, the current (the electrical energy) generated in the coil is stored in the secondary cell (the rechargeable battery) 370, and is then used as the energy for driving the watch and the energy for driving the variety of sensors.

As described above, in the power supply section 306, there is used the power generation system for generating the power using the solar light as natural energy easy for the user to obtain, or using the motion of the arm of the user (the wearer), and therefore, it is possible to use so-called clean energy having no influence on the environment as the power source (power supply). Further, it is possible to generate enough power for the power consumption of the electronic watch W3 with sensors by the self-power generation using the power supply section 306 provided with the self-power generation function, and it is possible to install the function such as the GPS relatively high in power consumption, the plurality of sensors, and so on.

According to the electronic watch W3 with sensors related to the third embodiment as the wrist apparatus described above, in addition to the advantages of the first embodiment, it becomes possible to easily change the design and the display information by displaying the information including the time and the information including the physical quantities detected by a variety of sensors and so on in the digital display section 305 (the LCD 334) using the indicating hands and the information display section displayed digitally.

### Modified Example of Wrist Apparatus

Then, a modified example of the wrist apparatus will be described with reference to FIG. 17. FIG. 17 is a perspective view showing a schematic configuration of the electronic watch with sensors according to a modified example of the wrist apparatus.

As shown in FIG. 17, the electronic watch W4 with sensors according to the modified example has a communication section 404 for transmitting and receiving signals including the information, and is connected to the other sensor apparatus C and electronic apparatuses (not shown) so as to communicate with each other via the communication section 404. Further, the electronic watch W4 with sensors is capable of displaying the second physical information detected by the other sensor apparatus C (e.g., a terminal device having a biological information measuring sensor) on the display section (not shown) using, for example, indicating hand 441. Further, the electronic watch W4 with sensors is capable of transmitting the location information obtained by the electronic watch W4 with sensors and the information detected by the sensors to an electronic apparatus such as a personal computer (PC) or a mobile apparatus to check the information.

It should be noted that the communication connection between the electronic watch W4 with sensors and the other sensor apparatus C and other electronic apparatuses (not shown) is capable of transmitting and receiving the signals using the wireless communication or the wired communication.

According to the present modified example, it is possible to transmit the location information and the information detected by the plurality of sensors to the electronic apparatus such as a personal computer (PC) or a mobile apparatus to check the information. Although the wrist apparatus has a relatively small display section due to the portability, in comparison with such a wrist apparatus, these electronic apparatuses use a large display section, and therefore, it is possible to display the necessary information in an eye-friendly manner. Further, it is possible to perform the exchange of the information between the user and other users.

As the terminal device, there is used an apparatus (the other sensor apparatus C) having a sensor function such as a biological information measuring sensor, or a portable communication terminal such as a smartphone, a cellular phone, or a feature phone. Alternatively, the terminal device can also be an information processing terminal such as a tablet computer. As the communication connection between the electronic watch W4 with sensors and the other sensor apparatus C (e.g., a terminal device having a biological information measuring sensor), it is possible to adopt the near-field wireless communication such as Bluetooth (registered trademark).

By providing the communication connection between the electronic watch W4 with sensors and the other sensor apparatus C (e.g., the terminal device having the biological information measuring sensor) as described above, it becomes possible to detect the information, which cannot be detected by the electronic watch W4 with sensors, using, for example, the other sensor apparatus C, and to display the second physical information and so on detected by the other sensor apparatus C on the display section (not shown) of the electronic watch W4 with sensors.

Further, by providing the communication connection between the electronic watch W4 with sensors and the other sensor apparatus C (e.g., the terminal device having a biological information measuring sensor), the information of a variety of physical quantities detected by the plurality of sensors provided to the electronic watch W4 with sensors can be displayed on the display section (not shown) of the other sensor apparatus C (the terminal device). It should be noted that the arithmetic processing of the information such as the pulse rate and the calorie consumption can be performed in the electronic watch W4 with sensors, or it is also possible to perform at least a part of the arithmetic processing in the other sensor apparatus C.

As described above, it is possible to transmit the location information and the information detected by the plurality of sensors to the electronic apparatus such as a personal computer (PC) or a mobile apparatus to check the information. Although the wrist apparatus (the electronic watch W4 with sensors) has a relatively small display section due to the portability, in comparison with such a wrist apparatus, these electronic apparatuses use a large display section, and therefore, it is possible to display the necessary information in an eye-friendly manner. Further, it is possible to perform the exchange of the information between the user and other users.

According to the electronic watch W4 with sensors related to the modified example of the wrist apparatus described above, it becomes possible to detect the information, which cannot be detected by the electronic watch W4 with sensors, such as the second physical information using the other sensor apparatus C (the terminal device), and then display the information on the display section of the electronic watch W4 with sensors using the indicating hand 441 and so on. As described above, the electronic watch W4 with sensors can be made as a device improved in usability.

It should be noted that it is desirable for the electronic watches W, W2, W3, and W4 with sensors to be provided with a so-called waterproof function of preventing the external moisture from entering the internal space formed by the top case 11, the bottom case 12, and the glass plate 18 of, for example, the apparatus main body 100. By providing such a waterproof function, it becomes possible to use, for example, in outdoor situations in which there are many chances of touching water, seawater, and so on.

Further, it is also possible for the electronic watches W, W2, W3, and W4 with sensors to be provided with the connection terminals with the external power supply in addition to the self-power generation function to charge (store) the secondary cells 108, 370 using the external power supply, and to use both of the charge (storage) by the external power supply and the charge (storage) by the self-power generation. By adopting such a configuration, it is possible for the user, for example, having a few chances of going outside or a few chances of exercise to use the electronic watch without worrying about the remaining battery level.

It should be noted that although in the embodiments described above, the explanation is presented illustrating the GPS satellites 8 as the location information satellite provided to the GPS system, this configuration is illustrative only. It is sufficient for the GPS system to be provided with the location information satellites for transmitting the satellite signal of other global positioning satellite system (GNSS) such as Galileo (EU), GLONASS (Russia), or BeiDou (China), or the stationary satellites or the quasi-zenith satellites such as SBAS. In other words, it is also possible for the electronic watches W, W2, W3, and W4 with sensors to have the configuration for obtaining either one of the date information, the time information, the location information, and the speed information figured out by processing the radio waves (the wireless signals) from the location information satellites including a satellite other than the GPS satellites 8.

The entire disclosure of Japanese Patent Application No. 2016-131381, filed Jul. 1, 2016 is expressly incorporated by reference herein.

What is claimed is:

1. A wrist apparatus comprising:
a receiving section adapted to receive a satellite signal transmitted from a location information satellite;
a plurality of sensors;
a power supply section provided with a self-power generation function; and
a display section adapted to display information using an indicating hand.

2. The wrist apparatus according to claim 1, wherein
the sensor includes either of an acceleration sensor, a pressure sensor, an orientation sensor, an illuminance sensor, a temperature sensor, and a humidity sensor each adapted to detect a physical quantity.

3. The wrist apparatus according to claim 1, wherein
the sensor is a biological information detection sensor including either of a pulse wave measurement sensor, a pulse rate measurement sensor, a blood pressure measurement sensor, a body temperature sensor, and a galvanic skin response sensor each adapted to detect biological information.

4. The wrist apparatus according to claim 3, further comprising:
a case adapted to house at least the receiving section; and
a back lid part disposed on a back side of the case,
wherein the biological information detection sensor is disposed on the back lid part.

5. The wrist apparatus according to claim 3, further comprising:
a case adapted to house at least the receiving section; and
a band part connected to the case,
wherein the biological information detection sensor is disposed in the band part.

6. The wrist apparatus according to claim 3, wherein
an index representing at least one of SpO₂ (percutaneous arterial blood oxygen saturation), VO₂ₘₐₓ (maximum oxygen uptake), body temperature, a lactate level, SvO₂ (oxygen saturation of hemoglobin), a sleeping condition, stress, a blood sugar level, arrhythmia, calorie consumption, metabolism, and ovulation is obtained from the biological information.

7. The wrist apparatus according to claim 1, wherein
the power supply section has at least either one of a power generation function of obtaining electrical energy due to a solar cell, and a power generation function of converting kinetic energy of a rotary weight to obtain electrical energy.

8. The wrist apparatus according to claim 1, further comprising:
a communication section adapted to transmit and receive a signal between the wrist apparatus and another electronic apparatus,
wherein the communication section performs transmission and reception of the signal with one of wireless communication and wired communication.

9. The wrist apparatus according to claim 1, wherein
the indicating hand is rotated by a rotary shaft connected to the indicating hand, and a drive section adapted to rotate the rotary shaft.

10. The wrist apparatus according to claim 1, wherein
the display section is provided with a digital display section displayed using digital display.

11. The wrist apparatus according to claim 10, wherein
the digital display section uses at least one of an electrophoretic display module, an organic electro-luminescence display and a liquid crystal display.

12. The wrist apparatus according to claim 1, wherein
the display section is provided with four or less small window sections.

13. The wrist apparatus according to claim 12, further comprising:
a plurality of operation modes in which operations corresponding respectively to the sensors are performed,
wherein at least one of the small window sections is provided with mode display sections corresponding respectively to the operation modes.

14. The wrist apparatus according to claim 4, wherein
the case is formed of metal.

15. The wrist apparatus according to claim 1, wherein
an antenna provided to the receiving section is at least one of a ring antenna and a patch antenna.

16. The wrist apparatus according to claim 1, further comprising:
at least one of a chronograph function and a dual time function.

17. The wrist apparatus according to claim 10, wherein
the information is displayed using both of analog display and digital display.

18. The wrist apparatus according to claim 1, further comprising:
a time correction section adapted to obtain time information included in the satellite signal to correct current time.

19. The wrist apparatus according to claim 18, further comprising:
a second receiving section adapted to receive a radio wave different in frequency from the satellite signal,
wherein the time correction section performs correction of time based on a result of the reception by one of the receiving section and the second receiving section.

20. The wrist apparatus according to claim 1, wherein
the wrist apparatus is connected to another sensor apparatus to display second physical information detected by the another sensor apparatus on the display section using the indicating hand.
